(19) United States
(12) Patent Application Publication
(10) Pub. No.: US 2026/0059460 A1
(43) Pub. Date: Feb. 26, 2026

(54) ADAPTATION OF RANDOM ACCESS CHANNEL PROCEDURE WITH DYNAMIC SYNCHRONIZATION SIGNAL BLOCK CONFIGURATION

(71) Applicant: QUALCOMM Incorporated, San Diego, CA (US)

(72) Inventors: Mohammed JABI, San Diego, CA (US); Ahmed Attia ABOTABL, San Diego, CA (US); Diana MAAMARI, San Diego, CA (US)

(21) Appl. No.: 18/815,463

(22) Filed: Aug. 26, 2024

(51) Int. Cl. H04W 56/00; H04W 72/1268; H04W 74/0833; H04W 76/28

(52) U.S. Cl. CPC H04W 56/0015; H04W 72/1268; H04W 74/0833; H04W 76/28

(57) ABSTRACT

Certain aspects of the present disclosure provide techniques for dynamic synchronization signal configuration and random access. A method for wireless communication by a user equipment may include receiving a first SSB configuration indicating a plurality of SSB transmissions and determining, based on the first SSB configuration, random access occasions of a set of ROs as valid or invalid and physical uplink shared channel occasions of a set of POs as valid or invalid. The method may include receiving an updated SSB configuration and re-determining, based on the updated SSB configuration, whether the ROs of the set of ROs are valid or invalid and whether the POs of the set of POs are valid or invalid. The method may include transmitting in the set of ROs and the set of POs based on the determination of the valid or invalid ROs and the valid or invalid POs.

### FIELD OF THE DISCLOSURE

Aspects of the present disclosure relate to wireless communications, and more particularly, to techniques for dynamic synchronization signal (SSB) configuration and random access.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication by a user equipment (UE). The method includes receiving a first synchronization signal block (SSB) configuration indicating a plurality of SSB transmissions; determining, based on the first SSB configuration, random access occasions (ROs) of a set of ROs as valid or invalid and physical uplink shared channel (PUSCH) occasions (POs) of a set of POs as valid or invalid; receiving an updated SSB configuration different than the first SSB configuration; re-determining, based on the updated SSB configuration, whether the ROs of the set of ROs are valid or invalid and whether the POs of the set of POs are valid or invalid; and transmitting in the set of ROs and the set of POs based on the determination of the valid or invalid ROs and the valid or invalid POs.

Another aspect provides a method for wireless communication by a network entity. The method includes outputting a first synchronization signal block (SSB) configuration indicating a plurality of SSB transmissions; determining, based on the first SSB configuration, random access occasions (ROs) of a set of ROs as valid or invalid and physical uplink shared channel (PUSCH) occasions (POs) of a set of POs as valid or invalid; outputting an updated SSB configuration different than the first SSB configuration; re-determining, based on the updated SSB configuration, whether the ROs of the set of ROs are valid or invalid and whether the POs of the set of POs are valid or invalid; and monitoring in the set of ROs and the set of POs based on the determination of the valid or invalid ROs and the valid or invalid POs.

Other aspects provide: an apparatus operable, configured, or otherwise adapted to perform any one or more of the aforementioned methods and/or those described elsewhere herein; a non-transitory, computer-readable media comprising instructions that, when executed (e.g., directly, indirectly, after pre-processing, without pre-processing) by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts a process flow for communications in a network between a network entity and a user equipment.

FIG. 6 depicts example SSBs interfering with fewer random access channel occasions after a dynamic SSB configuration change.

FIG. 7 depicts example invalid random access channel occasions and PUSCH occasions that remain invalid after a dynamic SSB configuration change.

FIG. 8 depicts example invalid random access channel occasions that remain invalid after a dynamic SSB configuration change and invalid PUSCH occasions that are valid after the dynamic SSB configuration change.

FIG. 9 depicts example invalid random access channel occasions and PUSCH occasions are valid after a dynamic SSB configuration change.

FIG. 10 depicts example SSBs interfering with additional random access channel occasions after a dynamic SSB configuration change.

FIG. 11 depicts example valid random access channel occasions and PUSCH occasions that are invalid after a dynamic SSB configuration change.

FIG. 12 depicts example valid random access channel occasions that are invalid after a dynamic SSB configuration change and valid PUSCH occasions that remain valid after the dynamic SSB configuration change.

FIG. 13 depicts example valid random access channel occasions and PUSCH occasions that remain valid after a dynamic SSB configuration change.

FIG. 14 depicts example SSBs interfering with fewer physical uplink shared channel (PUSCH) occasions after a dynamic SSB configuration change.

FIG. 15 depicts example invalid PUSCH occasions that remain invalid after a dynamic SSB configuration change.

FIG. 16 depicts example invalid PUSCH occasions that are valid after a dynamic SSB configuration change.

FIG. 17 depicts example SSBs interfering with additional PUSCH occasions after a dynamic SSB configuration change.

FIG. 18 depicts example valid PUSCH occasions that are invalid after a dynamic SSB configuration change.

FIG. 19 depicts example valid PUSCH occasions that remain valid after a dynamic SSB configuration change.

FIG. 20 depicts a method for wireless communications by a UE.

FIG. 21 depicts a method for wireless communications by a network entity.

FIG. 22 depicts aspects of an example communications device.

FIG. 23 depicts aspects of an example communications device.

### DETAILED DESCRIPTION

Aspects of the present disclosure provide apparatuses, methods, processing systems, and computer-readable mediums for an adaptive RACH procedure with dynamically updated SSB configuration.

The network transmits SSBs to the UEs that can be used for purposes such as synchronization, radio resource measurements, radio link measurements, and/or other purposes. In some systems, an initial SSB configuration can configure SSB transmission. For example, the initial SSB configuration may configure an SSB periodicity, an SSB burst size, a location of SSBs with an SSB burst, and/or other parameters of SSB transmission. SSB transmission may involve a high overhead of network and UE resources. In some systems, the SSB configuration may be dynamically updated, which may provide improved network energy savings. For example, an initial SSB configuration may be provided to a UE in system information, such as in the system information block (SIB1) and the SSB configuration may be dynamically updated, such as via downlink control information (DCI).

In some systems, collision handling rules are configured to specify how to handle collisions between SSBs and random access channel (RACH) preamble occasions or physical uplink shared channel (PUSCH) occasions. As used herein, a “collision” between an SSB and a RACH occasion or an SSB and PUSCH occasion is used to refer to an SSB and RO or PO that satisfy one or more conditions specified by the configured collision handling rules, where a collision may refer to a partial or full overlap of an SSB with an RO or PO, a SSB within a specified time duration threshold of an RO or PO, or other conditions specified in configured collision handling rules. Based on the collision handling rules, ROs and POs may be determined as valid or invalid.

Current collision handling rules may only consider the initial SSB configuration in the determination of the valid or invalid ROs and POs. However, after the SSB configuration is dynamically adapted, ROs or POs determined as valid may now collide with an SSB and ROs or POs determined as invalid may no longer collide with an SSB. The current collision handling may not account for these changes, which may lead to inefficient use of UE and network resources.

Aspects of the present disclosure provide techniques and apparatus for the UE and network to consider the dynamically updated SSB configuration in determining, or re-determining, whether the ROs and POs are valid or invalid. The RACH procedure may be adapted based on the determination of the valid and invalid ROs and POs. For example, based on the valid or invalid ROs, the UE may determine whether to transmit or drop a RACH preamble transmission. Based on the valid or invalid POs, the UE may determine whether transmit or drop a PUSCH transmission. Based on the valid or invalid ROs and POs, the network entity may determine whether to transmit or drop SSBs and whether or not to monitor a RACH preamble or a PUSCH transmission. The UE and/or network entity may realize network energy savings by using the adapted RACH procedure.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

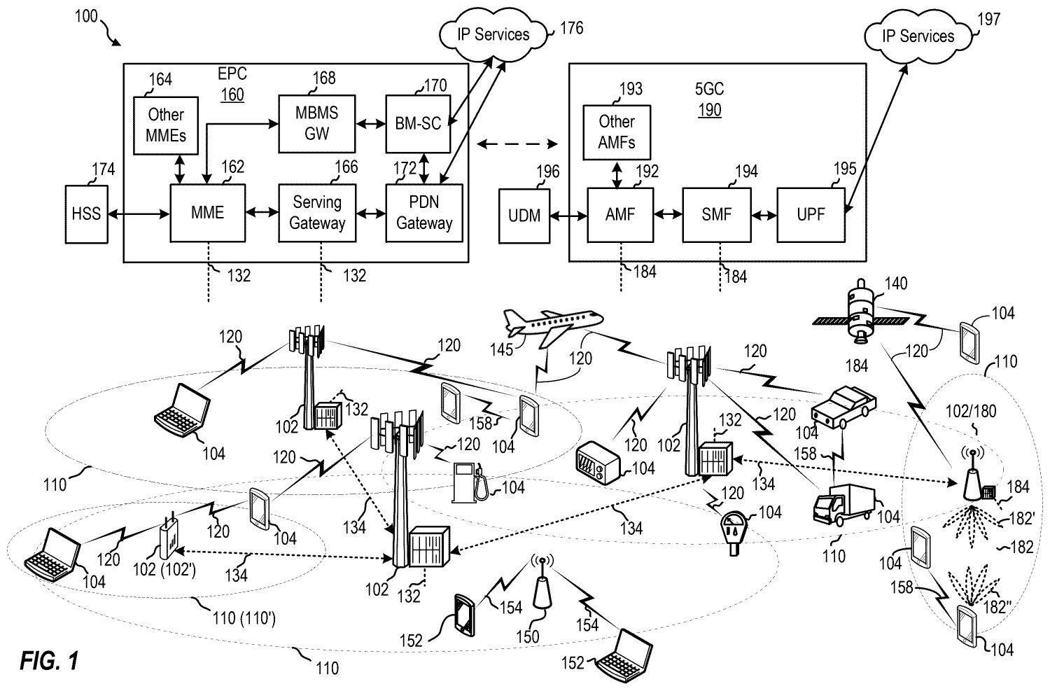

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

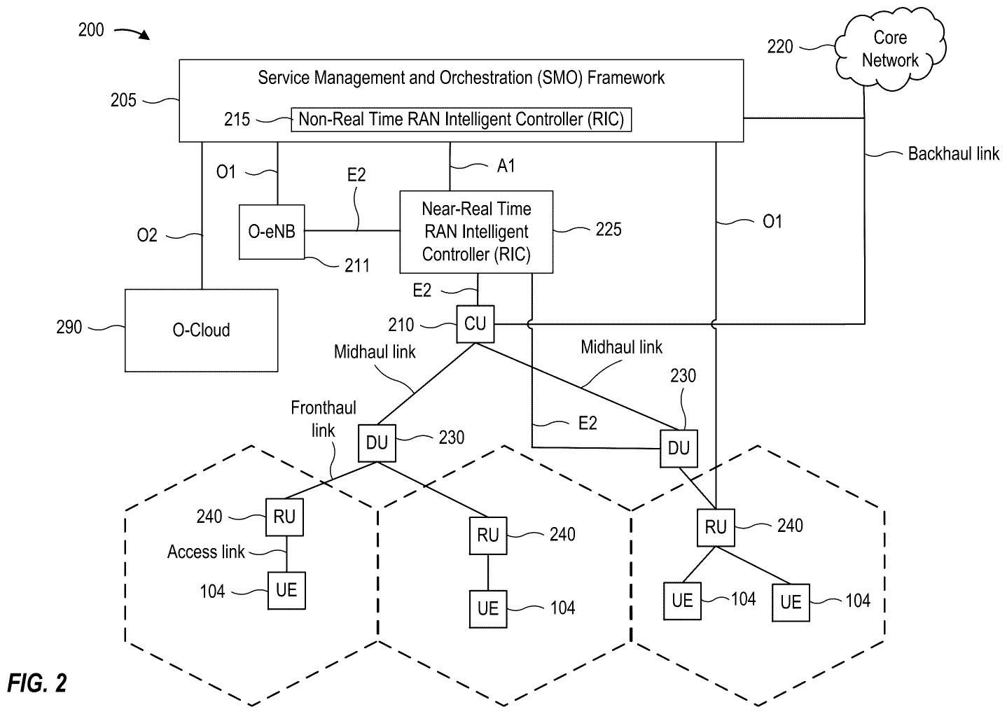

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz - 7125 MHz, which is often referred to (interchangeably) as “Sub-6 GHz”. Similarly, 3GPP currently defines Frequency Range 2 (FR2) as including 24,250 MHz - 71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz - 52,600 MHz and a second sub-range FR2 -2 including 52,600 MHz - 71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit—User Plane (CU-UP)), control plane functionality (e.g., Central Unit—Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

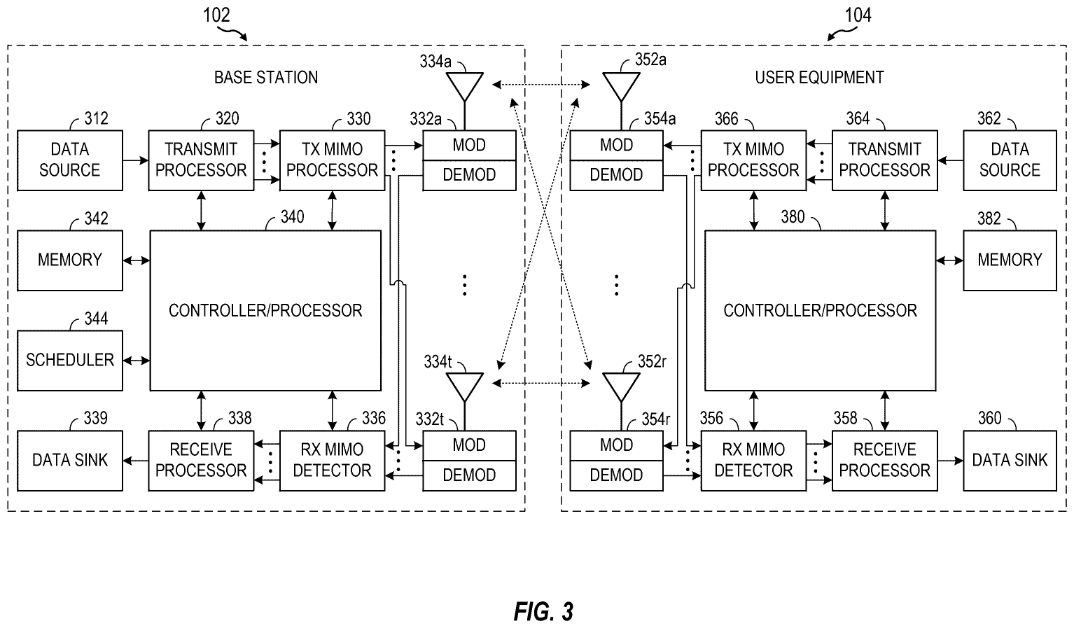

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, one or more processors may be configured to perform various operations, such as those associated with the methods described herein, and transmit (output) to or receive (obtain) data from another interface that is configured to transmit or receive, respectively, the data.

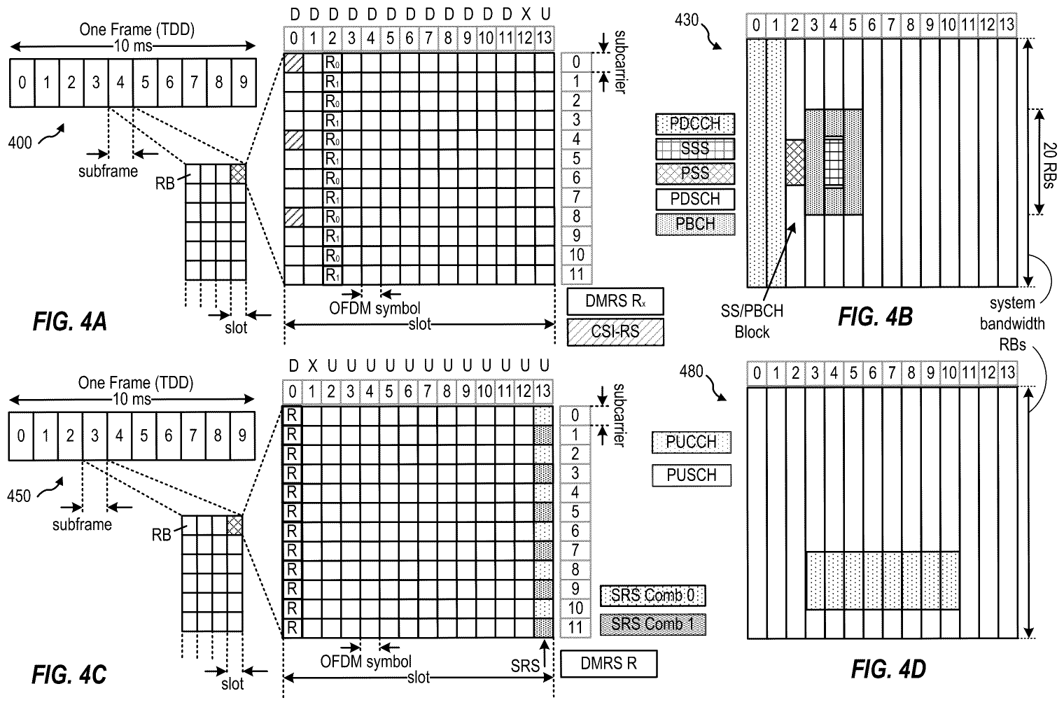

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 6 allow for 1, 2, 4, 8, 16, 32, and 64 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2 μ slots/subframe. The subcarrier spacing and symbol length/duration are a function of the numerology. The subcarrier spacing may be equal to 2^{μ}×15 kHz, where μ is the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Dynamic SSB Configuration

Network energy savings has become an area of interest for some wireless communication networks, such as 5G NR, 6G, and beyond. Efficient management of network resources and reduction of energy consumption may be important to ensuring fast and reliable connectivity. For example, working groups for 3GPP Release 19 NR systems are studying on-demand SSB for Secondary Cell (Scell) operation for UEs in connected mode and configured with inter-band or intra-band carrier aggregation; signaling to support on-demand System Information Block 1 (SIB1) for UEs in idle/inactive mode; and adaptation of common signal/channel transmissions.

SSBs help keep devices (e.g., UEs) in sync with cell towers (e.g., gNBs). For example, UEs may use SSBs for initial time and frequency synchronization, identifying a physical cell identifier (PCI), measuring reference signal receive power (RSRP), measuring reference signal receive quality (RSRQ), measuring signal-to-interference-plus-noise ratio (SINR), tracking, radio resource management (RRM) measurements, and/or radio link monitoring (RLM) measurements.

Optimizing SSB transmission and monitoring may improve network efficiency and performance. For example, when a UE is idle or inactive, unnecessary SSB signaling may occur, which needlessly consumes power and network resources without benefit to the user. Thus, the SSB configuration may be dynamically adapted in the time domain to improve network efficiency. For example, the SSB burst periodicity may be dynamically adapted, SSB configurations may be dynamically switched, SSB bursts may be dynamically skipped (e.g., non-uniformly), the number of SSBs within an SSB burst may be dynamically adapted; and/or cell discontinuous transmission (DTX) may be dynamically adapted, the position of SSBs within an SSB burst may be dynamically adapted. The SSB adaptation may be signaled by the base station to the UE.

Dynamic SSB adaptation may be supported in cells with legacy (e.g., not supported one or more network energy savings features) and non-legacy UEs (e.g., supporting the one or more network energy savings features). Dynamic SSB adaptation may be supported in a primary cell (PCell) or Secondary Cell (SCell). Dynamic SSB adaptation may be supported for cell defining (CD) SSB, non-CD (NCD) SSB, and/or for SSBs not on the sync raster.

While dynamic SSB adaptation may help provide network energy savings, changing the SSB configuration may impact the collision of SSBs with other signals. In some cases, a set of collision handling rules may be configured. For example, TS 38.213, Release-18, Section 8.1A, specifies a set of collision handling rules.

For a Type-2 random access procedure, a UE transmits a PUSCH, when applicable, after transmitting a PRACH (e.g., the PRACH and PUSCH correspond to the MsgA). The PUSCH transmission is after the PRACH transmission by at least N symbols is based on the SCS configuration for the active uplink (UL) bandwidth part (BWP). According to example collision handling rules, a UE does not transmit a PUSCH in a PUSCH occasion if the PUSCH occasion associated with a DMRS resource is not mapped to a preamble of valid PRACH occasions. A UE can transmit a PRACH preamble in a valid PRACH occasion if the PRACH preamble is not mapped to a valid PUSCH occasion.

A mapping between one or multiple PRACH preambles and a PUSCH occasion associated with a DMRS resource is per PUSCH configuration provided by signalling from the network. For example, the mapping may signalled in a MsgA-PUSCH-Resource (e.g., a parameter in a MsgA-PUSCH-Config RRC IE in a MsgA-ConfigCommon RRC IE in a BWP-UplinkCommon RRC IE in a BWP-Uplink RRC IE). A UE can determine time resources and frequency resources for PUSCH occasions in an active UL BWP from the msgA-PUSCH-Config or a separateMsgA-PUSCH-Config for the active UL BWP. If the active UL BWP is not the initial UL BWP and msgA-PUSCH-Config or separateMsgA-PUSCH-Config is not provided for the active UL BWP, the UE may use the msgA-PUSCH-Config or separateMsgA-PUSCH-Config provided for the initial UL BWP.

For mapping one or multiple preambles of a PRACH slot to a PUSCH occasion associated with a DMRS resource, a UE may determine a first slot for a first PUSCH occasion in an active UL BWP from msgA-PUSCH-TimeDomainOffset (e.g., carried in the msgA-PUSCH-Config) that provides an offset, in number of slots in the active UL BWP, relative to the start of a PUSCH slot including the start of each PRACH slot. The UE does not expect to have a PRACH preamble transmission and a PUSCH transmission with a msgA in a PRACH slot or in a PUSCH slot, or to have overlapping msgA PUSCH occasions for a MsgA PUSCH configuration. The UE expects that a first PUSCH occasion in each slot has a same SLIV for a PUSCH transmission that is provided by startSymbolAndLengthMsgA-PO (e.g., carried in the msgA-PUSCH-Config) or msgA-PUSCH-timeDomainAllocation (e.g., carried in the msgA-PUSCH-Config).

According to the example collision handling rules, a PUSCH occasion is valid if it does not overlap in time and frequency with any valid PRACH occasion associated with either a Type-1 random access procedure or a Type-2 random access procedure.

The RRC IE ServingCellConfigCommon is used by the network to configure cell specific parameters of a UE's serving cell. The ServingCellConfigCommon IE contains parameters which a UE may otherwise acquire from SSB, MIB or SIBs when accessing the cell from an RRCE IDLE state. The network may provide the ServingCellConfigCommon IE in dedicated signalling when configuring a UE with a SCells or with an additional cell group (SCG). The ServingCellConfigCommon IE may also be provide for SpCells (MCG and SCG) upon reconfiguration with sync.

The ServingCellConfigCommon IE may include a parameter (e.g., ssb-PositionsInBurst). For operation in licensed spectrum, ssb-PositionsInBurst indicates the time domain positions of the transmitted SS-blocks in a half frame with SS/PBCH blocks. A first/leftmost bit corresponds to SS/PBCH block index 0, a second bit corresponds to SS/PBCH block index 1, and so on. A value of 0 in the bitmap indicates that the corresponding SS/PBCH block is not transmitted while value 1 indicates that the corresponding SS/PBCH block is transmitted. The network may configure the same pattern in this field as in a corresponding field in a ServingCellConfigCommonSIB.

For operation with shared spectrum channel access, only mediumBitmap is used and the UE may assume that one or more SS/PBCH blocks indicated by ssb-PositionsInBurst may be transmitted within the discovery burst transmission window and have candidate SS/PBCH blocks indexes corresponding to SS/PBCH block indexes provided by ssb-PositionsInBurst. If the k-th bit of ssb-PositionsInBurst is set to 1, the UE may assume that one or more SS/PBCH blocks within the discovery burst transmission window with candidate SS/PBCH block indexes corresponding to SS/PBCH block index equal to k−1 may be transmitted. If the kt-th bit is set to 0, the UE may assume that the corresponding SS/PBCH block(s) are not transmitted. The k-th bit may be set to 0, where k>ssb-PositionQCL and the number of actually transmitted SS/PBCH blocks is not larger than the number of 1's in the bitmap.

According to the example collision handling rules, for unpaired spectrum and for SS/PBCH blocks with indexes provided by ssb-PositionsInBurst in the initial SIB (e.g., SIB1) or by ServingCellConfigCommon, if a UE is not provided tdd-UL-DL-ConfigurationCommon (e.g., in the ServingCellConfigCommon IE or the ServingCellConfigCommonSIB IE in SIB1), a PUSCH occasion is valid if the PUSCH occasion does not precede a SS/PBCH block in the PUSCH slot, and starts at least a threshold number of symbols, N_{gap}, after a last SS/PBCH block symbol.

Further, if the network indicates a channel access procedure to apply operation with shared spectrum channel access (e.g., channelAccessMode field in the ServingCellConfigCommon IE or the ServingCellConfigCommonSIB IE) as semi-static (e.g., semiStatic), then, according to the example collision handling rules, the PUSCH occasion is valid further if it does not overlap with a set of consecutive symbols before the start of a next channel occupancy time where the UE does not transmit.

Further, if a UE is provided with the tdd-UL-DL-ConfigurationCommon, then, according to the example collision handling rules, the PUSCH occasion a PUSCH occasion is valid if the PUSCH occasion is within UL symbols, or, if the PUSCH occasion does not precede a SS/PBCH block in the PUSCH slot and starts at least N_{gap} symbols after a last downlink symbol and at least N_{gap} symbols after a last SS/PBCH block symbol.

Generally, the collision handling rules may protect the serving cell SSBs by giving the SSB priority over a MsgA PUSCH payload, in MsgA PUSCH payload occasions, in the two-step random access procedure. In some cases, the example collision handling rules consider the set of resources configured for SSBs, for example, which may be configured via a SIB1 or in a ServingCellConfigCommon.

With dynamic SSB configuration, however, the resources configured for the SSBs changes dynamically. Current collision handling may not account for changes to the SSB configuration. Accordingly, resources may be used inefficiently, for example, as resources considered invalid for the initial SSB configuration according to the collision handling rules would become valid for the updated SSB configuration, but go unused. As another example, resources considered valid for the initial SSB configuration according to the collision handling rules may become invalid for the updated SSB configuration, and resources may be wasted due to transmitting or monitoring in those resources which may experience interference due to collisions.

Accordingly, what is needed are techniques and apparatus for collision handling to improve efficiency of random access with dynamic SSB configuration.

### Aspects Related to Adaptation of Random Access with Dynamic SSB Configuration

According to certain aspects, a dynamically updated SSB configuration may be considered in adapting a random access procedure. In some aspects, the dynamically updated SSB configuration may be considered in applying configured collision handling rules. In some aspects, the dynamically updated SSB configuration may be used in determine valid and invalid random access occasions (ROs) for sending a RACH preamble. In some aspects, the dynamically updated SSB configuration may be used in determine valid and invalid PUSCH occasions (POs) for sending a PUSCH transmission.

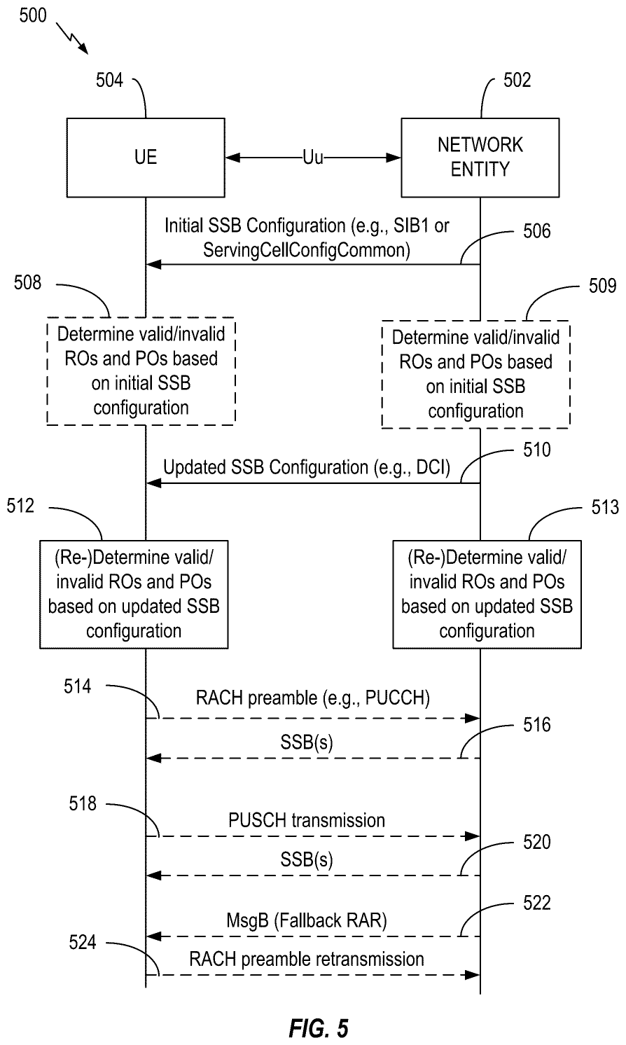

FIG. 5 depicts a process flow 500 for communications in a network between a network entity 502, a UE 504. In some aspects, the network entity 502 may be an example of the BS 102 depicted and described with respect to FIGS. 1 and 3 or a disaggregated base station depicted and described with respect to FIG. 2. Similarly, the UE 504 may be an example of UE 104 depicted and described with respect to FIGS. 1 and 3. However, in other aspects, UE 104 may be another type of wireless communications device and network entity 502 may be another type of network entity or network node, such as those described herein.

As shown in FIG. 5, the process flow 500 may include the UE 504 receiving an initial SSB configuration from the network entity 502 at operation 506. In some aspects, the initial SSB configuration may be received before an initial access procedure has been performed between the UE 504 and network entity 502. In some aspects, the initial SSB may refer to a most recent SSB configuration, which may not be a “first” SSB configuration from the network entity 502, but a last received SSB configuration received from the network entity 502, which could be an updated SSB configuration.

In some aspects, the initial SSB configuration may be received in system information, such as in a system information block (SIB). In some aspects, the initial SSB configuration is received in a SIB1. In some aspects, the initial SSB configuration may be received in an RRC message. In some aspects, the initial SSB configuration is received in a ServingCellConfigCommon IE. In some aspects, the initial SSB configuration indicates one or more time and/or frequency resources for SSB transmission. The initial SSB configuration may indicate an SSB periodicity (e.g., ssb-periodicityServingCell), an SSB burst size (e. g, longBitmap, mediumBitmap, shortBitmap, indicating 4, 8, 64 SSBs per half frame respectively), and/or a location of SSBs within an SSB burst (e.g., ssb-PositionsInBurst).

As shown in FIG. 5, the process flow 500 may include the UE 504 determining valid/invalid ROs and POs based on the initial SSB configuration at operation 508.

In some aspects, the UE 504 receives a random access configuration (e.g., in a MsgA-PUSCH-Config RRC IE or separateMsgA-PUSCH-Config) from the network entity 502. For example, the UE 504 may be configured with a mapping of PRACH preambles to PUSCH occasions (e.g., a MsgA-PUSCH-Resource parameter).

In some aspects, the RA configuration from the network entity 502 includes, but is not limited to, a parameter indicating a number of PRBs per PUSCH occasion (e.g., nrofPRBs-PerMsgA-PO) and a parameter indicating an intra-slot frequency hopping per PUSCH occasion (e.g., msgA-IntraSlotFrequencyHopping).

In some aspects, the RA configuration from the network entity 502 includes, but is not limited to, a parameter indicating a number of slots containing one or multiple PUSCH occasions (e.g., nrofSlotsMsgA-PUSCH), a parameter indicating a single time offset with respect to the start of each PRACH slot counted as the number of slots (based on the numerology of active UL BWP) (e.g., msgA-PUSCH-TimeDomainOffset), and either a parameter indicating an index giving valid combinations of start symbol, length and mapping type as start and length indicator (SLIV) for the first MsgA PUSCH occasion, for RRC_CONNECTED UEs in non-initial BWP (e.g., startSymbolAndLengthMsgA-PO) or a parameter indicating a combination of start symbol and length and PUSCH mapping type from a configured time domain resource allocation (TDRA) table (e.g., msgA-PUSCH-timeDomainAllocation).

In some aspects, the UE 504 determines the valid/invalid ROs and POs based on the initial SSB configuration, the random access configuration, and one or more configured collision handling rules (e.g., such as the example collision handling rules described herein). For example, based on the example configured collision handling rules, ROs and/or POs determined from the random access configuration may be determined as valid or invalid based on whether the ROs and/or POs collide with SSBs resources determined from the initial SSB configuration. Based on the configured collision handling rules, a collision may be an actual full or partial overlap in time/frequency resource overlap or may be that the SSB and RO/PO resources are within a specified threshold of each other.

As shown FIG. 5 at operation 509, the network entity 502 may also determine whether the ROs and POs are valid or invalid based on the SSB configuration, random access configuration, and collision handling rules.

As shown in FIG. 5, the process flow 500 may include the UE 504 receiving an updated SSB configuration from the network entity 502 at operation 510. In some aspects, the updated SSB configuration is a new SSB configuration, different than the initial SSB configuration. In some aspects, the updated SSB configuration updates one or more parameters of the initial SSB configuration.

In some aspects, transmitting the updated SSB configuration via DCI may provide advantages. For example, transmitting an SSB configuration via SIB1 may involve sweeping over all beams to transmit the SSB configuration, whereas transmitting via DCI can target a specific UE or sets of UEs. This may reduce power used for updating an SSB configuration. In addition, transmission of an SSB configuration may be limited to the 160 ms SIB1 periodicity, where DCI can be used to change the SSB configuration with higher flexibility at any time.

As shown in FIG. 5, the process flow 500 may include the UE 504 re-determining valid/invalid ROs and POs based on the updated SSB configuration at operation 512. In some aspects, the UE 504 may determine one or more POs and/or ROs as valid, based on the updated SSB configuration, that were determined as invalid at operation 508 based on the initial SSB configuration.

Similarly, UE 504 may determine one or more POs and/or ROs as invalid, based on the updated SSB configuration, that were determined as valid at operation 508 based on the initial SSB configuration. For example, SSB resources determined from the initial SSB that did not collide, based on the collision handling rules, with any ROs and/or POs determined from the random access configuration and therefore determined valid, may now collide with one or more ROs and/or POs based on the updated SSB configuration.

In some aspects, the UE 504 may not have determined valid/invalid ROs and POs at the operation 508, and determines whether the POs and ROs are valid or invalid at the operation 512 based on the updated SSB configuration, for example, before the UE 504 performs a RACH procedure. In this case, the UE 504 may determine one or more ROs and/or POs as valid or invalid that would have been invalid or valid based on the initial SSB configuration.

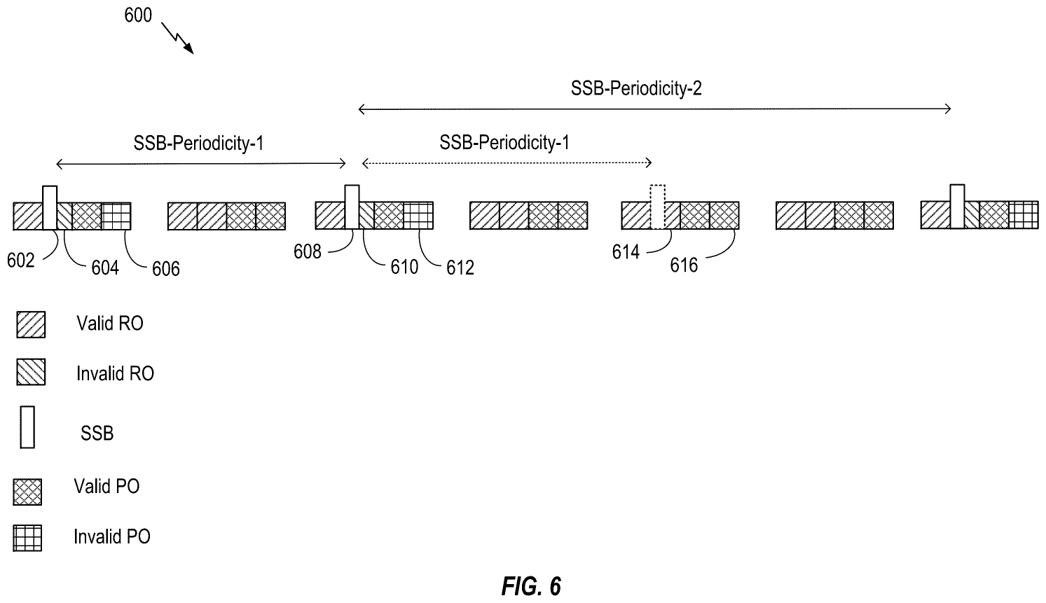

Aspects of the process flow 500 with examples of collision handling and RACH procedure adaptation based on dynamically updated SSB configuration are described with respect to the FIGS. 6-19. While aspects are described with respect to a two-step RACH procedure, it should be understand that the collision handling aspects described herein can equally be used in a four-step RACH other procedure.

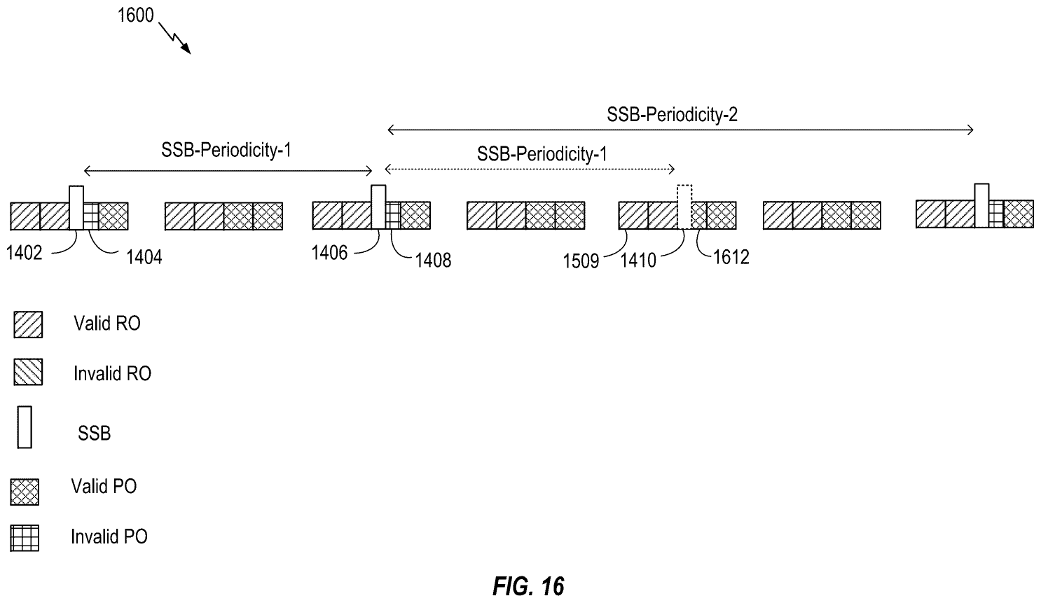

In addition, FIGS. 16-19 illustrate a dynamically updated SSB periodicity, however, it should be understood that the updated SSB configuration may update other parameters of the SSB configuration including any combination of the SSB configuration parameters described herein.

Further, FIGS. 16-19 illustrate a collision as an SSB partially overlapping an RO or PO, however, it should be understood that a collision may be any collision as determined based on collision handling rules including the example collision handling rules described herein, such as an overlap or partial overlap of SSB with an RO or PO, or an SSB being within a configured time domain threshold distance of an RO or PO.

FIGS. 6-9 illustrate an example of collision handling and RACH procedure adaptation in which dynamically updated SSB configuration results in fewer collisions between SSBs and ROs.

As shown in FIG. 6, an initial SSB configuration may configure SSBs with a first SSB periodicity, SSB-Periodicity-1. Under the first SSB periodicity, SSB 602 collides with RO 604 and the SSB 608 collides with the RO 610. Thus, under example collision handling rules, the ROs 604 and 610 and the associated POs 606 and 612, mapped to the ROs 604 and 610, are invalid. As shown, the SSB configuration is dynamically updated to a longer second SSB periodicity, SSB-Periodicity-2. In the illustrated example, under the SSB-Periodicity-1, the RO 614 would collide with an SSB rendering the RO 614 and associated PO 616 invalid, however, under the SSB-Periodicity-2, the RO 614 does not collide with an SSB.

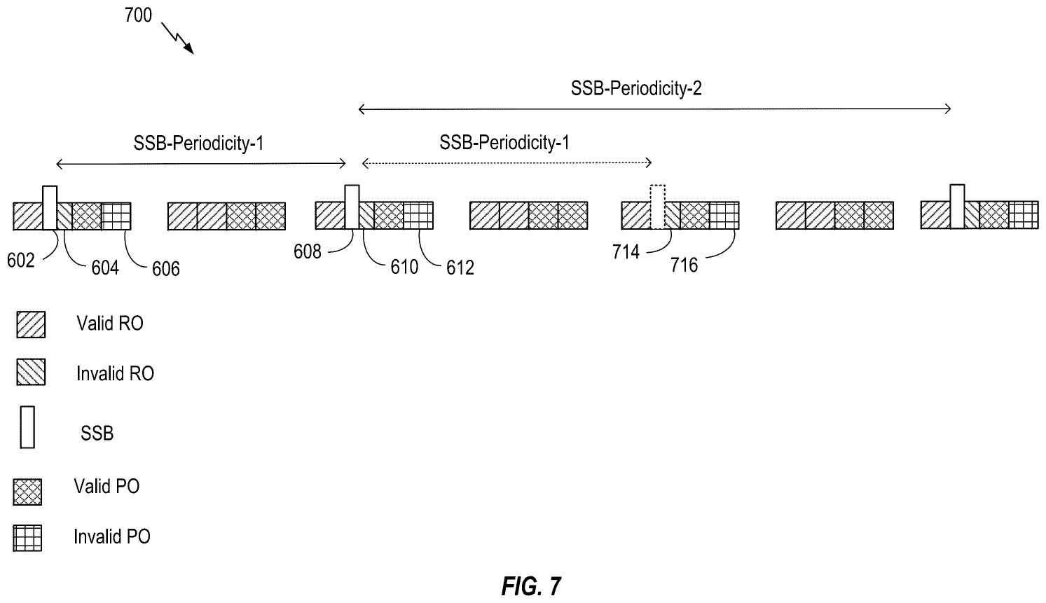

According to certain aspects, an RO that is invalid under the initial SSB configuration remains invalid under the updated SSB configuration, although the RO does not collide with an SSB under the updated SSB configuration. According to certain aspects, the PO associated with the RO also remains invalid. As shown in FIG. 7, although the RO 714 does not collide with an SSB after the SSB configuration is updated to the SSB-Periodicity-2, the RO 714 is considered invalid because the RO 714 was invalid under the initial SSB configuration. Further, the PO 716 mapped to the RO 714 remains invalid.

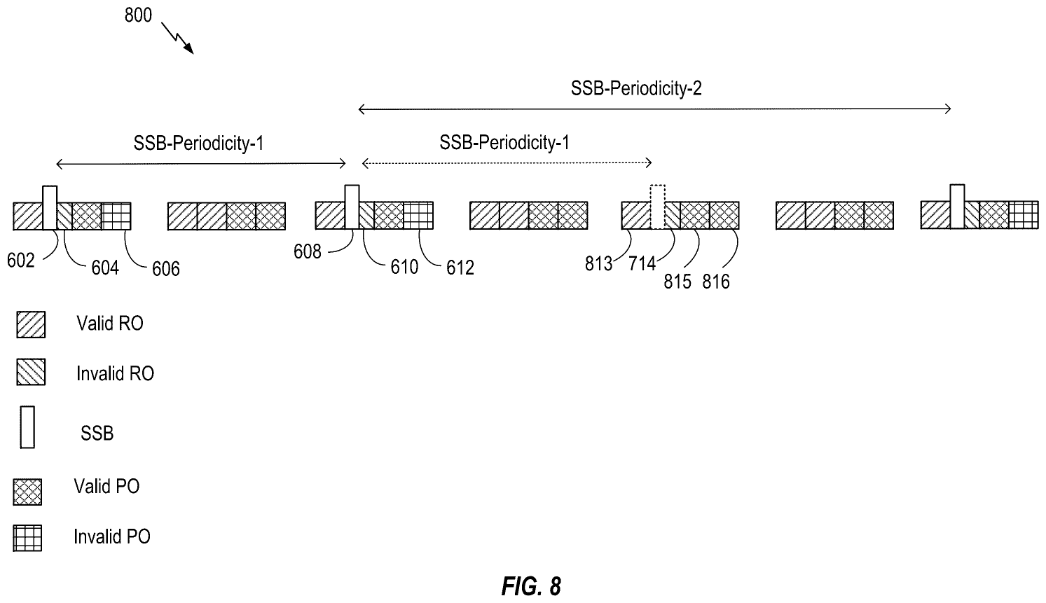

Alternatively, the PO associated with the RO becomes valid. As shown in FIG. 8, although the RO 714 does not collide with an SSB after the SSB configuration is updated to the SSB-Periodicity-2, the RO 714 is considered invalid because the RO 714 was invalid under the initial SSB configuration, however, the PO 816 mapped to the RO 714 is considered valid. In some aspects, a new mapping is defined between the valid PO 816 to one of the valid ROs, for example, to RO 813. In the example illustrated in FIG. 8, the UE 504 may be configured with a mapping of RO 813 to both valid POs 815 and 816. In some aspects, the UE 504 is configured with multiple mappings for ROs to POs. For example, a first mapping may be used when the ROs are valid and a different mapping may be used when an RO is invalid.

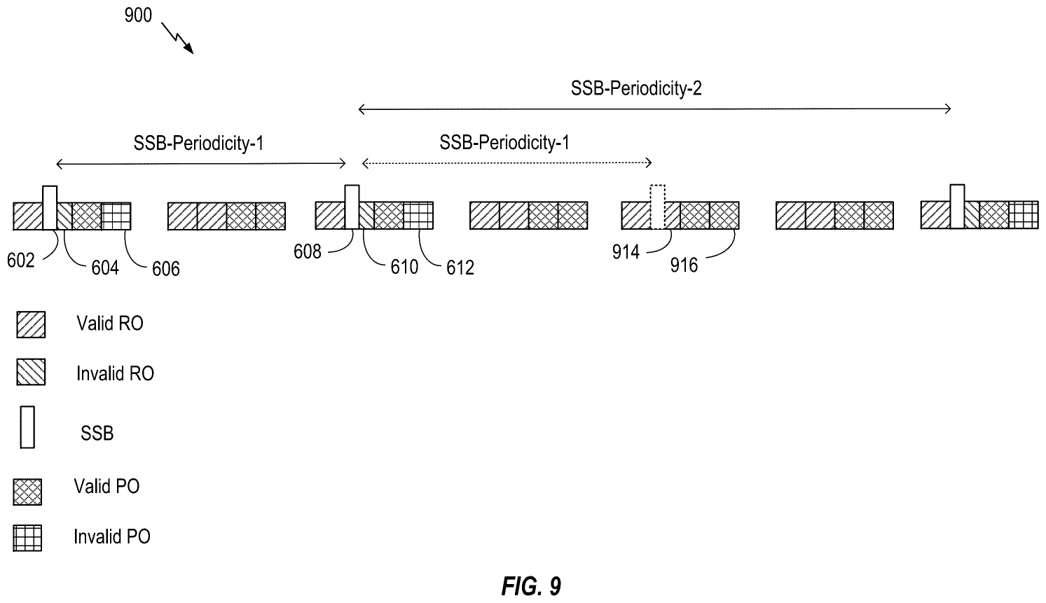

According to certain aspects, an RO that is invalid under the initial SSB configuration is considered valid under the updated SSB configuration, when the RO does not collide with an SSB under the updated SSB configuration. According to certain aspects, the PO associated with the RO also is considered valid. As shown in FIG. 9, after the dynamic SSB configuration change to the SSB-Periodicity-2, the RO 914 does not collide with an SSB and the RO 914 is considered valid, even though the RO 914 was invalid under the initial SSB configuration. Further, the PO 916 mapped to the RO 914 is considered valid.

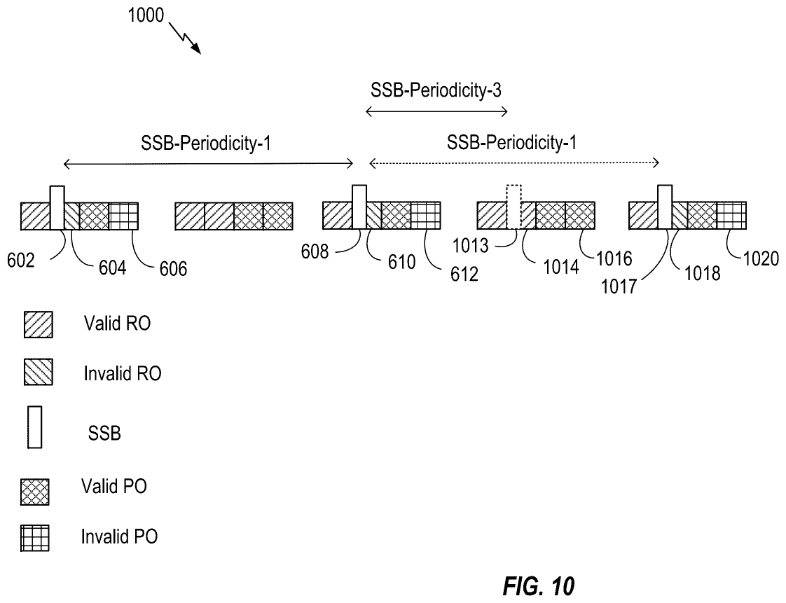

FIGS. 10-13 illustrate an example of collision handling and RACH procedure adaptation in which dynamically updated SSB configuration results in additional collisions between SSBs and ROs.

As shown in FIG. 10, and as described with respect to FIG. 6, the initial SSB configuration may configure SSBs with the first SSB periodicity, SSB-Periodicity-1. Under the first SSB periodicity, the SSB 602 collides with RO 604, the SSB 608 collides with the RO 610, and the SSB 1017 collides with the RO 1018. Thus, under example collision handling rules, the ROs 604, 610, and 1018, and the associated POs 606, 612, and 1020 mapped to the ROs 604, 610, and 1018 are invalid, whereas the RO 1014 would not collide with any SSB and would be valid along with the associated PO 1016 mapped to the RO 1014. As shown, the SSB configuration is dynamically updated to a shorter second SSB periodicity, SSB-Periodicity-3. In the illustrated example, under the SSB-Periodicity-3, the RO 1014 now collides with the SSB 1013.

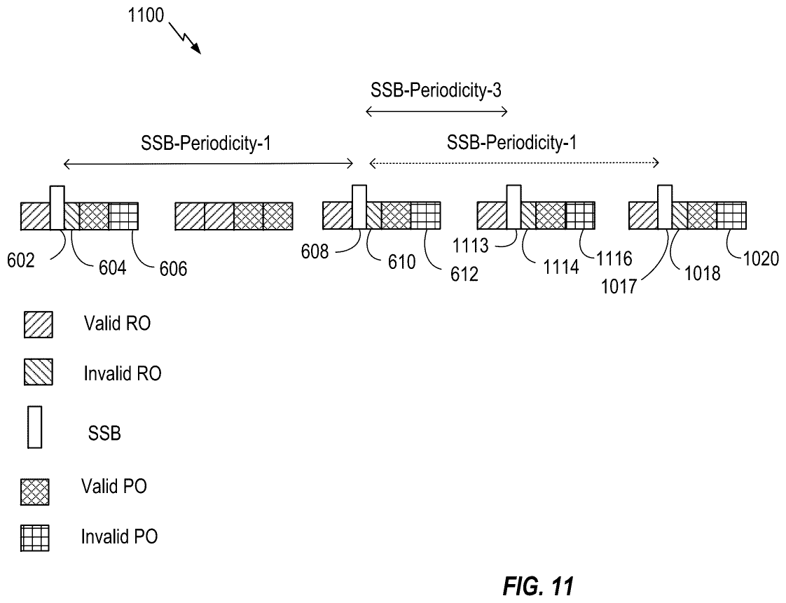

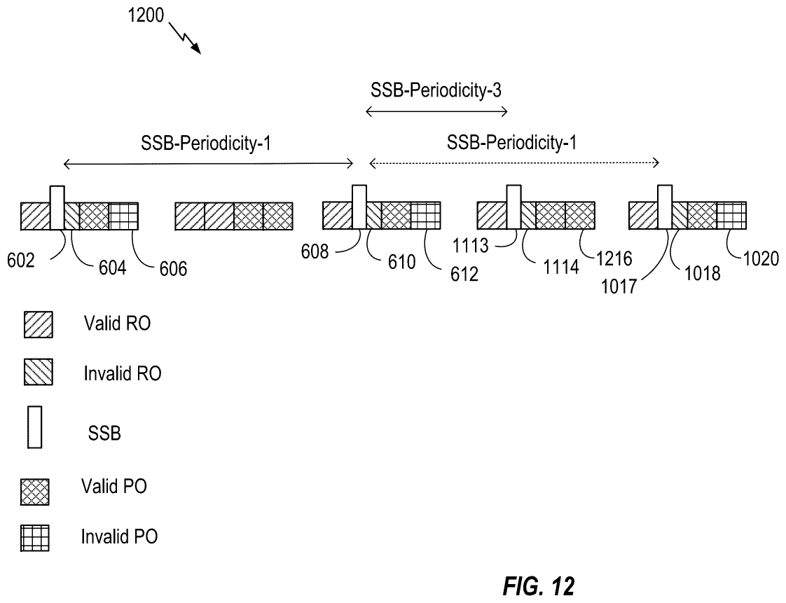

According to certain aspects, an RO that is valid under the initial SSB configuration is considered invalid under the updated SSB configuration, when the RO collides with an SSB under the updated SSB configuration. According to certain aspects, the PO associated with the RO also is considered invalid. As shown in FIG. 11, after the dynamic SSB configuration change to the SSB-Periodicity-3, the RO 1114 that now collides with the SSB 1113 is considered invalid, even though the RO 1114 was valid under the initial SSB configuration. Further, the PO 1116 mapped to the RO 1114 is considered invalid. According to certain aspects, the PO associated with the RO is still considered valid as shown in FIG. 12, the RO 1114 becomes invalid after the dynamic SSB configuration but the PO 1216 associated with the RO 1114 is still considered valid. As discussed above, the valid PO associated with the invalid RO may be remapped to a valid RO.

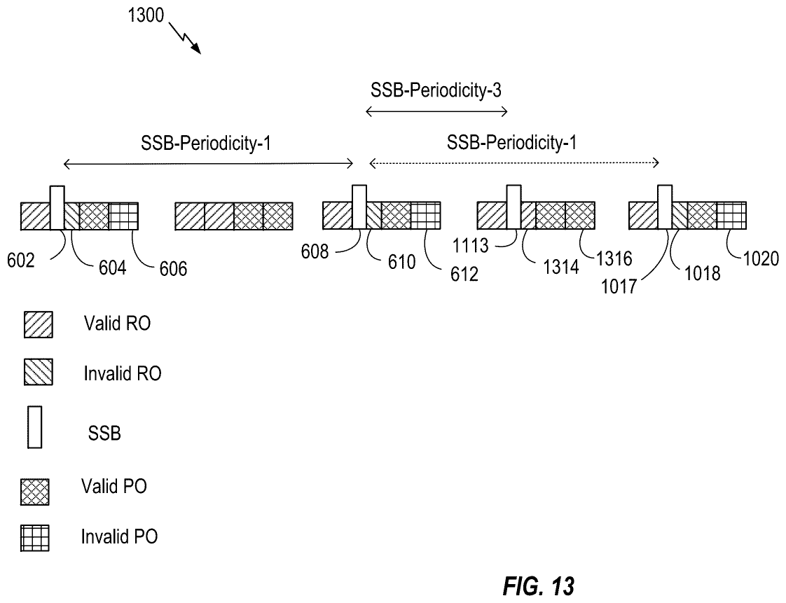

According to certain aspects, an RO that is valid under the initial SSB configuration is still considered valid under the updated SSB configuration, although the RO collides with an SSB under the updated SSB configuration. According to certain aspects, the PO associated with the RO also is considered valid. As shown in FIG. 13, after the dynamic SSB configuration change to the SSB-Periodicity-3, the RO 1314 that now collides with the SSB 1113 is still considered valid, where though the RO 1314 was valid under the initial SSB configuration. Further, the PO 1316 mapped to the RO 1314 is also still considered valid. As discussed in more detail below with respect to FIG. 5, the network entity 502 may drop the colliding SSB 1113.

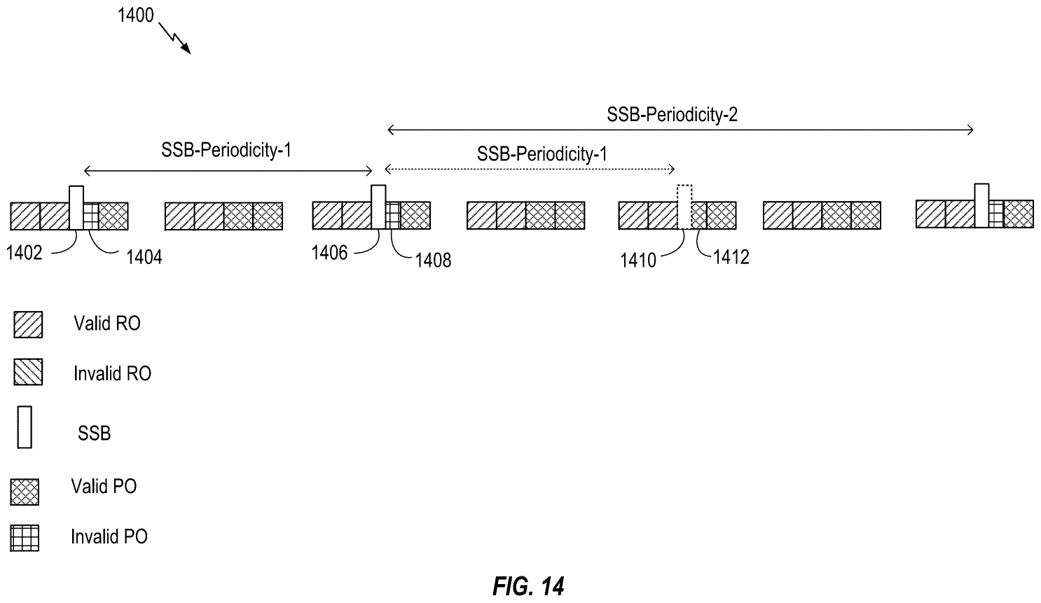

FIGS. 14-16 illustrate an example of collision handling and RACH procedure adaptation in which dynamically updated SSB configuration results in fewer collisions between SSBs and POs. In the examples illustrated in FIGS. 14-16, for collision handling of SSB with POs, it is assumed that the ROs mapped to the POs do not collide with an SSB.

As shown in FIG. 14, an initial SSB configuration may configure SSBs with a first SSB periodicity, SSB-Periodicity-1. Under the first SSB periodicity, SSB 1402 collides with PO 1404, the SSB 1406 collides with the PO 1408, and the SSB 1410 would collide with the PO 1412. Thus, under example collision handling rules, the POs 1404, 1408, and 1412 are invalid. As shown, the SSB configuration is dynamically updated to a longer second SSB periodicity, SSB-Periodicity-2. In the illustrated example, under the SSB-Periodicity-2, the PO 1412 now does not collide with an SSB.

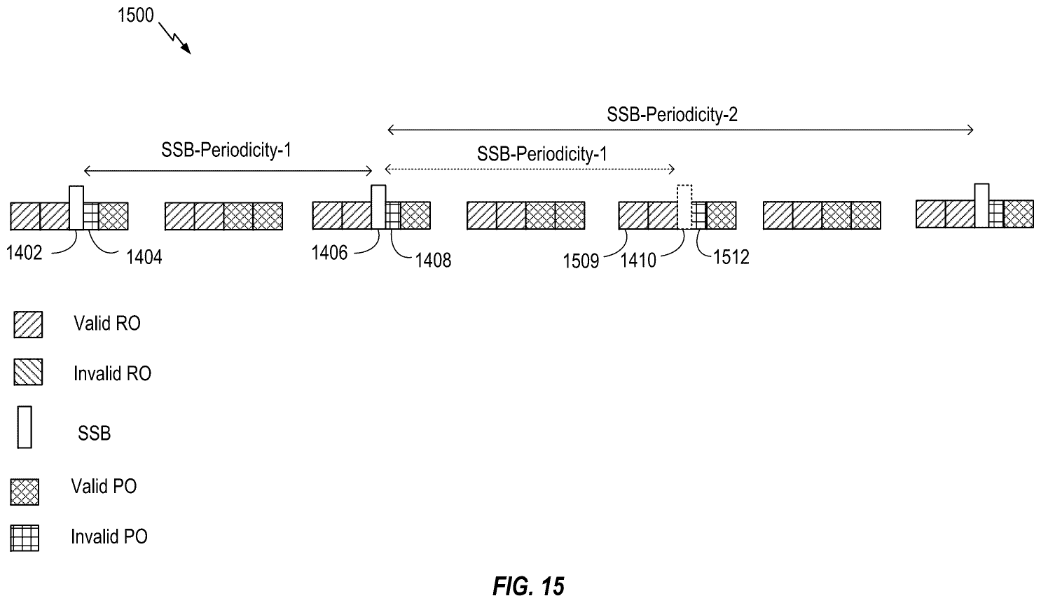

According to certain aspects, a PO that is invalid under the initial SSB configuration remains invalid under the updated SSB configuration, although the PO does not collide with an SSB under the updated SSB configuration. As shown in FIG. 15, although the PO 1512 does not collide with an SSB after the SSB configuration is updated to the SSB-Periodicity-2, the PO 1512 is still considered invalid because the PO 1512 was invalid under the initial SSB configuration.

As discussed in more detail below with respect FIG. 5, in some aspects, the UE 504 drops the PUSCH payload in the PO 1512 mapped to the RO 1509 when the PO 1512 is considered invalid. According to certain aspects, the RO 1509 mapped to the invalid PO 1512 is remapped to a valid PO. In some aspects, multiple mapping of the RO 1509 to one or more POs are configured. One mapping for the RO 1509 may be used when the PO 1512 is valid and a different mapping may be used for the RO 1509 when the PO 1514 is invalid. In some aspects, the RO 1509 is mapped to a valid PO that is also mapped to another valid RO. In some aspects, the number of physical resource units (PRUs) in the valid PO may be increased when the new mapping is used.

According to certain aspects, a PO that is invalid under the initial SSB configuration is considered valid under the updated SSB configuration, when the PO does not collide with an SSB under the updated SSB configuration. As shown in FIG. 16, the PO 1612 does not collide with an SSB after the SSB configuration is updated to the SSB-Periodicity-2 and the PO 1612 is considered valid, although the PO 1612 was invalid under the initial SSB configuration.

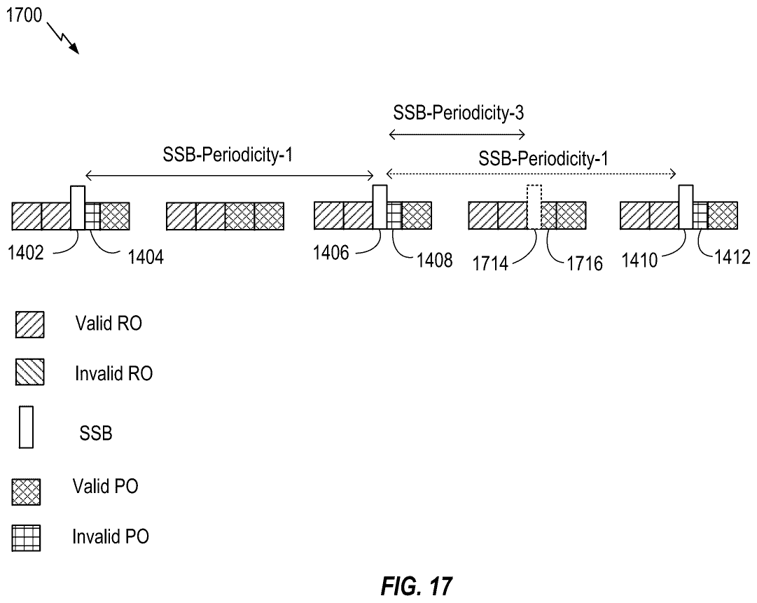

FIGS. 17-19 illustrate an example of collision handling and RACH procedure adaptation in which dynamically updated SSB configuration results in additional collisions between SSBs and POs.

As described above with respect to FIG. 14, the initial SSB configuration may configure SSBs with the first SSB periodicity, SSB-Periodicity-1. Under the first SSB periodicity, SSB 1402 collides with PO 1404, the SSB 1406 collides with the PO 1408, and the SSB 1410 would collide with the PO 1412. Thus, under example collision handling rules, the POs 1404, 1408, and 1412 are invalid. As shown in FIG. 17, the SSB configuration is dynamically updated to a shorter second SSB periodicity, SSB-Periodicity-3. In the illustrated example, under the SSB-Periodicity-3, the PO 1716 now collides with an SSB 1714.

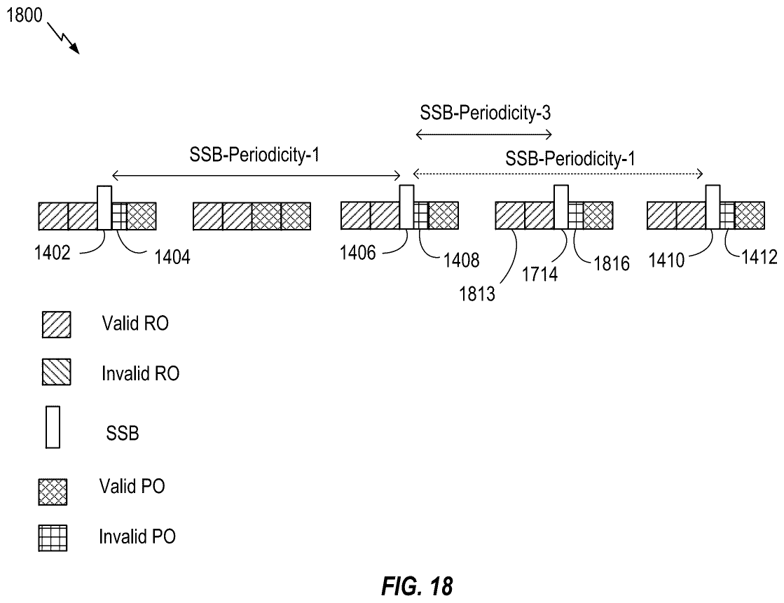

According to certain aspects, a PO that is valid under the initial SSB configuration is considered invalid under the updated SSB configuration, when the PO collides with an SSB under the updated SSB configuration. As shown in FIG. 18, the PO 1816 now collides with the SSB 1714 after the SSB configuration is updated to the SSB-Periodicity-3, and the PO 1816 is considered invalid, although the PO 1816 was valid under the initial SSB configuration.

As discussed in more detail below with respect FIG. 5, in some aspects, the UE 504 drops the PUSCH payload in the PO 1816 mapped to the RO 1813 when the PO 1816 is considered invalid. According to certain aspects, the RO 1813 mapped to the invalid PO 1816 is remapped to a valid PO. In some aspects, multiple mapping of the RO 1813 to one or more POs are configured. One mapping for the RO 1813 may be used when the PO 1816 is valid and a different mapping may be used for the RO 1813 when the PO 1816 is invalid. In some aspects, the RO 1813 is mapped to a valid PO that is also mapped to another valid RO. In some aspects, the number of PRUs in the valid PO may be increased when the new mapping is used.

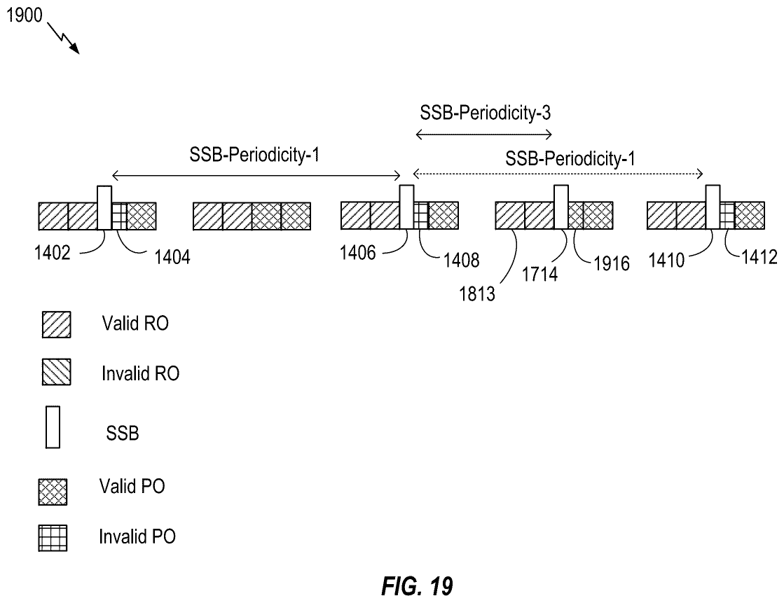

According to certain aspects, a PO that is valid under the initial SSB configuration remains valid under the updated SSB configuration, although the PO collides with an SSB under the updated SSB configuration. As shown in FIG. 19, the PO 1916 now collides with the SSB 1714 after the SSB configuration is updated to the SSB-Periodicity-3, and the PO 1916 is still considered valid, where the PO 1916 was valid under the initial SSB configuration. As discussed in more detail below with respect to FIG. 5, the network entity 502 may drop the colliding SSB 1714.

Referring back to the FIG. 5, the RACH procedure may be adapted based on the (re-)determination of the valid or invalid ROs and POs at operations 512.

In some aspects, the network entity 502 transmits SSBs according to the dynamically updated SSB configuration at operations 516 and/or 520. In some aspects, the network entity 502 drops an SSB transmission that collides with an RO or PO considered valid under the updated SSB configuration. In some aspects, the network entity 502 drops the SSB transmission in an RO or PO considered invalid under the updated SSB configuration, even where the SSB does not collide with the RO or PO under the updated SSB configuration.

In some aspects, the UE 504 transmits a RACH preamble in valid ROs at operation 514. In some aspects, the UE 504 transmits the RACH preamble in ROs considered valid under the updated SSB configuration, even where an SSB collides with the RO under the updated SSB configuration. In some aspects, the UE 504 drops the RACH preamble transmission in ROs considered invalid under the updated SSB configuration, even where an SSB does not collide with the RO under the updated SSB configuration. In some aspects, the network entity 502 does not monitor a RACH transmission in the ROs considered invalid, even where an SSB does not collide with the RO under the updated SSB configuration.

In some aspects, the UE 504 transmits a PUSCH (e.g., MsgA PUSCH payload) in valid POs. In some aspects, the UE 504 transmits the PUSCH in PO considered valid under the updated SSB configuration, even when an SSB collides with the PO under the updated SSB configuration. In some aspects, the UE 504 drops the PUSCH transmission in a PO considered invalid under the updated SSB configuration, even where an SSB does not collide with the PO under the updated SSB configuration. In some aspects, the network entity 502 does not monitor a PUSCH transmission in the POs considered invalid under the updated SSB configuration, even where an SSB does not collide with the PO under the updated SSB configuration. In some aspects, the network entity 502 monitors a PUSCH transmission in a PO considered valid under the updated SSB configuration, even where an SSB collides with the PO under the updated SSB configuration.

In some aspects, when a PO is considered invalid and the corresponding RO is valid, the UE 504 may transmit the RACH preamble in the RO but drops the corresponding PUSCH in the PO mapped to the RO. Thus, the network entity 502 may only be able to detect the RACH preamble and not the msgA PUSCH payload. In some aspects, the network entity 502 sends a MsgB with a fallback random access response (RAR), at operation 524, that indicates for the UE 504 to fall back to the four-step RACH procedure using an uplink grant and timing advance provided in the fallback RAR. In some aspects, the network entity 502 does not transmit any MsgB in response a corrected decoded RACH preamble in an RO mapped to an invalid PO. In this case, the UE 504 may repeat transmission of the RACH preamble, at operation 524, with a corresponding MsgA payload.

### Example Operations

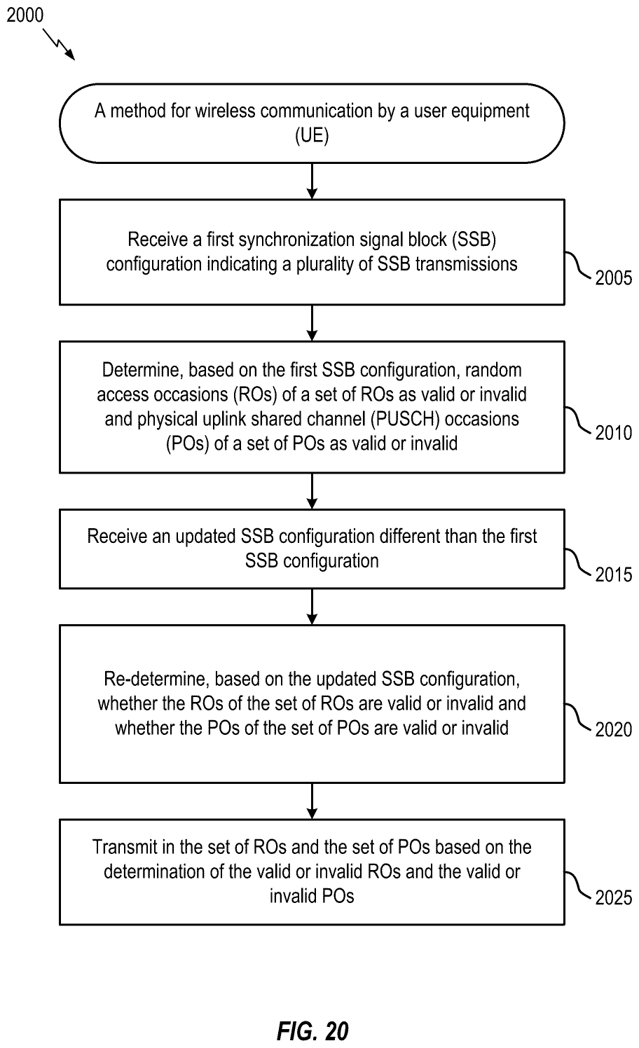

FIG. 20 shows an example of a method 2000 of wireless communication by a user equipment (UE), such as a UE 104 of FIGS. 1 and 3.

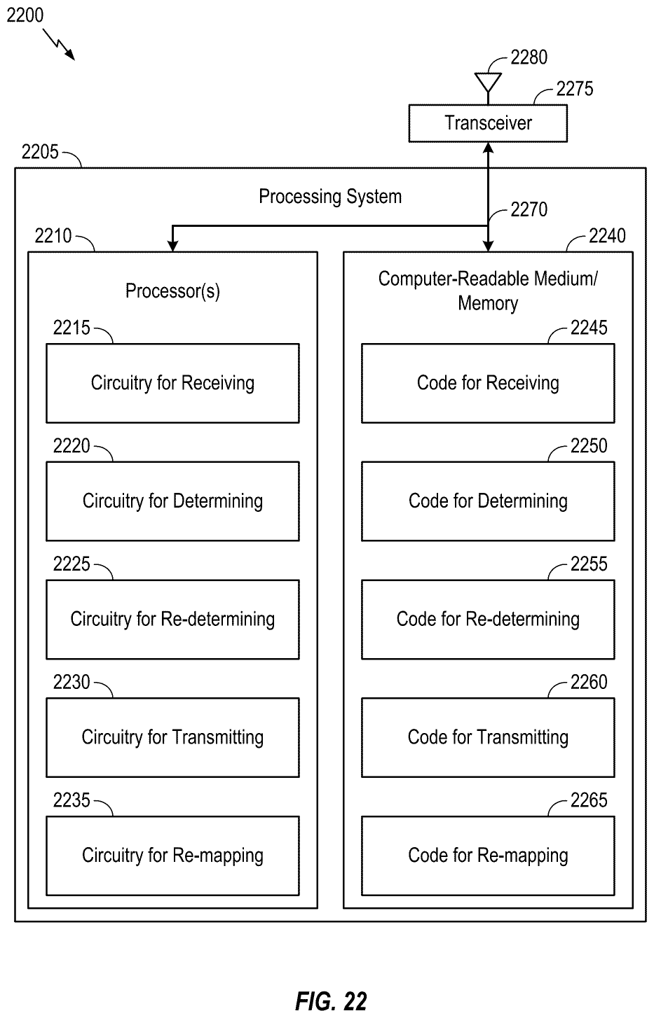

Method 2000 begins at step 2005 with receiving a first synchronization signal block (SSB) configuration indicating a plurality of SSB transmissions. In some cases, the operations of this step refer to, or may be performed by, circuitry for receiving and/or code for receiving as described with reference to FIG. 22.

Method 2000 then proceeds to step 2010 with determining, based on the first SSB configuration, random access occasions (ROs) of a set of ROs as valid or invalid and physical uplink shared channel (PUSCH) occasions (POs) of a set of POs as valid or invalid. In some cases, the operations of this step refer to, or may be performed by, circuitry for determining and/or code for determining as described with reference to FIG. 22.

Method 2000 then proceeds to step 2015 with receiving an updated SSB configuration different than the first SSB configuration. In some cases, the operations of this step refer to, or may be performed by, circuitry for receiving and/or code for receiving as described with reference to FIG. 22.

Method 2000 then proceeds to step 2020 with re-determining, based on the updated SSB configuration, whether the ROs of the set of ROs are valid or invalid and whether the POs of the set of POs are valid or invalid. In some cases, the operations of this step refer to, or may be performed by, circuitry for re-determining and/or code for re-determining as described with reference to FIG. 22.

Method 2000 then proceeds to step 2025 with transmitting in the set of ROs and the set of POs based on the determination of the valid or invalid ROs and the valid or invalid POs. In some cases, the operations of this step refer to, or may be performed by, circuitry for transmitting and/or code for transmitting as described with reference to FIG. 22.

In some aspects, determining, based on the first SSB configuration, whether the ROs of the set of ROs are valid or invalid and whether the POs of the set of POs are valid or invalid is further based on one or more configured rules for determining validity or invalidity of the ROs and POs.

In some aspects, determining, based on the first SSB configuration, the ROs of the set of ROs as valid or invalid and the POs of the set of POs as valid or invalid comprises: determining, based on the first SSB configuration, first overlap between one or more SSB transmissions of the plurality of SSB transmissions and at least one of: one or more ROs of the set of ROs or one or more POs of the set of POs; and determining, based on the first overlap and the one or more configured rules, the ROs of the set of ROs as valid or invalid and the POs of the set of POs as valid or invalid.

In some aspects, determining, based on the first overlap and the one or more configured rules, the ROs of the set of ROs as valid or invalid and the POs of the set of POs as valid or invalid comprises: determining a PO of the one or more POs of the set of POs as invalid when the PO precedes an SSB of the one or more SSBs transmissions in a PUSCH slot; determining a PO of the one or more POs of the set of POs as invalid when the PO starts within a preconfigured threshold number of symbols after a last symbol of an SSB of the one or more SSBs transmissions; and determining a PO of the one or more POs of the set of POs as valid when the PO does not precede an SSB of the one or more SSBs transmissions in a PUSCH slot and does not start within the preconfigured threshold number of symbols after the last symbol of the SSB of the one or more SSBs transmissions.

In some aspects, re-determining, based on the updated SSB configuration and the one or more configured rules, whether the ROs of the set of ROs are valid or invalid and whether the POs of the set of POs are valid or invalid comprises: determining, based on the updated SSB configuration, second overlap between one or more SSB transmissions of the plurality of SSB transmissions and at least one of: one or more ROs of the set of ROs or one or more POs of a set of POs, wherein the second overlap at least one of: includes overlap between one or more SSBs and at least one of: one or more ROs or one or more POs not included in the first overlap; or excludes overlap between one or more SSBs and at least one of: one or more ROs or one or more POs included in the first overlap; and determining, based on the second overlap and the one or more configured rules, at least one of: one or more of the valid ROs of the set of ROs as valid or invalid and one or more of the invalid ROs of the set of ROs as invalid or valid; and one or more of the valid POs of the set of POs as valid or invalid and one or more invalid POs of the set of POs as invalid or valid.

In some aspects, re-determining, based on the updated SSB configuration, whether the ROs of the set of ROs are valid or invalid comprises: re-determining an RO previously determined as invalid based on the first SSB configuration and the one or more configured rules as invalid, wherein the RO would be valid based on the updated SSB configuration and the one or more configured rules.

In some aspects, re-determining, based on the updated SSB configuration, whether the POs of the set of POs are valid or invalid comprises: re-determining a PO mapped to the RO as invalid, wherein the PO would be valid based on the updated SSB configuration and the one or more configured rules.

In some aspects, re-determining, based on the updated SSB configuration, whether the POs of the set of POs are valid or invalid comprises: re-determining a PO mapped to the invalid RO as valid.

In some aspects, the method 2000 further includes re-mapping the PO to a valid RO. In some cases, the operations of this step refer to, or may be performed by, circuitry for re-mapping and/or code for re-mapping as described with reference to FIG. 22.

In some aspects, re-determining, based on the updated SSB configuration, whether the ROs of the set of ROs are valid or invalid comprises: re-determining an RO previously determined as invalid based on the first SSB configuration and the one or more configured rules as valid, wherein the RO is valid based on the updated SSB configuration and the one or more configured rules.

In some aspects, re-determining, based on the updated SSB configuration, whether the POs of the set of POs are valid or invalid comprises: re-determining a PO mapped to the RO as valid.

In some aspects, re-determining, based on the updated SSB configuration, whether the ROs of the set of ROs are valid or invalid comprises: re-determining an RO previously determined as valid based on the first SSB configuration and the one or more configured rules as invalid, wherein the RO is invalid based on the updated SSB configuration and the one or more configured rules.

In some aspects, re-determining, based on the updated SSB configuration, whether the POs of the set of POs are valid or invalid comprises: re-determining a PO mapped to the RO as invalid.

In some aspects, re-determining, based on the updated SSB configuration, whether the POs of the set of POs are valid or invalid comprises: re-determining a PO mapped to the RO as valid.

In some aspects, re-determining, based on the updated SSB configuration, whether the ROs of the set of ROs are valid or invalid comprises: re-determining an RO previously determined as valid based on the first SSB configuration and the one or more configured rules as valid, wherein the RO would be invalid based on the updated SSB configuration and the one or more configured rules.

In some aspects, re-determining, based on the updated SSB configuration, whether the POs of the set of POs are valid or invalid comprises: re-determining a PO mapped to the RO as valid.

In some aspects, re-determining, based on the updated SSB configuration, whether the POs of the set of POs are valid or invalid comprises: re-determining a PO previously determined as invalid based on the first SSB configuration and the one or more configured rules as invalid, wherein the PO would be valid based on the updated SSB configuration and the one or more configured rules.

In some aspects, re-determining, based on the updated SSB configuration, whether the ROs of the set of ROs are valid or invalid comprises: re-determining an RO mapped to the PO as valid, wherein the RO is valid based on both the first SSB configuration and the one or more configured rules and the updated SSB configuration and the one or more configured rules.

In some aspects, the method 2000 further includes re-mapping the valid RO to a valid PO. In some cases, the operations of this step refer to, or may be performed by, circuitry for re-mapping and/or code for re-mapping as described with reference to FIG. 22.

In some aspects, re-determining, based on the updated SSB configuration, whether the POs of the set of POs are valid or invalid comprises: re-determining a PO previously determined as invalid based on the first SSB configuration and the one or more configured rules as valid, wherein the PO would be valid based on the updated SSB configuration and the one or more configured rules.

In some aspects, re-determining, based on the updated SSB configuration, whether the POs of the set of POs are valid or invalid comprises: re-determining a PO previously determined as valid based on the first SSB configuration and the one or more configured rules as invalid, wherein the PO is invalid based on the updated SSB configuration and the one or more configured rules.

In some aspects, the method 2000 further includes re-mapping a valid RO, mapped to the invalid PO, to a valid PO. In some cases, the operations of this step refer to, or may be performed by, circuitry for re-mapping and/or code for re-mapping as described with reference to FIG. 22.

In some aspects, re-determining, based on the updated SSB configuration, whether the POs of the set of POs are valid or invalid comprises: re-determining a PO previously determined as valid based on the first SSB configuration and the one or more configured rules as valid, wherein the PO would be invalid based on the updated SSB configuration and the one or more configured rules.

In some aspects, transmitting in the set of ROs and the set of POs based on the determination of the valid or invalid ROs and the valid or invalid POs comprises: transmitting a random access preamble of a random access channel (RACH) message of a two-step RACH procedure in the valid ROs; and transmitting a PUSCH transmission of the RACH message of the two-step RACH procedure in the valid POs.

In some aspects, receiving the first SSB configuration comprises receiving the first SSB configuration in an initial system information block (SIB1) or in a radio resource control (RRC) reconfiguration message; and receiving the updated SSB configuration comprises receiving the updated SSB configuration before receiving a next SIB1 or RRC reconfiguration message.

In some aspects, the first SSB configuration indicates at least one of: a first SSB burst periodicity, a first number of SSBs within the SSB burst, a first cell discontinuous transmission (DRX) configuration for SSB transmission, a first SSB burst skipping configuration, or a first location of SSBs within the SSB burst; and the updated SSB configuration indicates at least one of: a second SSB burst periodicity, a second number of SSBs within the SSB burst, a second cell DTX configuration for SSB transmission, a second SSB burst skipping configuration, or a second location of SSBs within the SSB burst.

In one aspect, method 2000, or any aspect related to it, may be performed by an apparatus, such as communications device 2200 of FIG. 22, which includes various components operable, configured, or adapted to perform the method 2000. Communications device 2200 is described below in further detail.

Note that FIG. 20 is just one example of a method, and other methods including fewer, additional, or alternative steps are possible consistent with this disclosure.

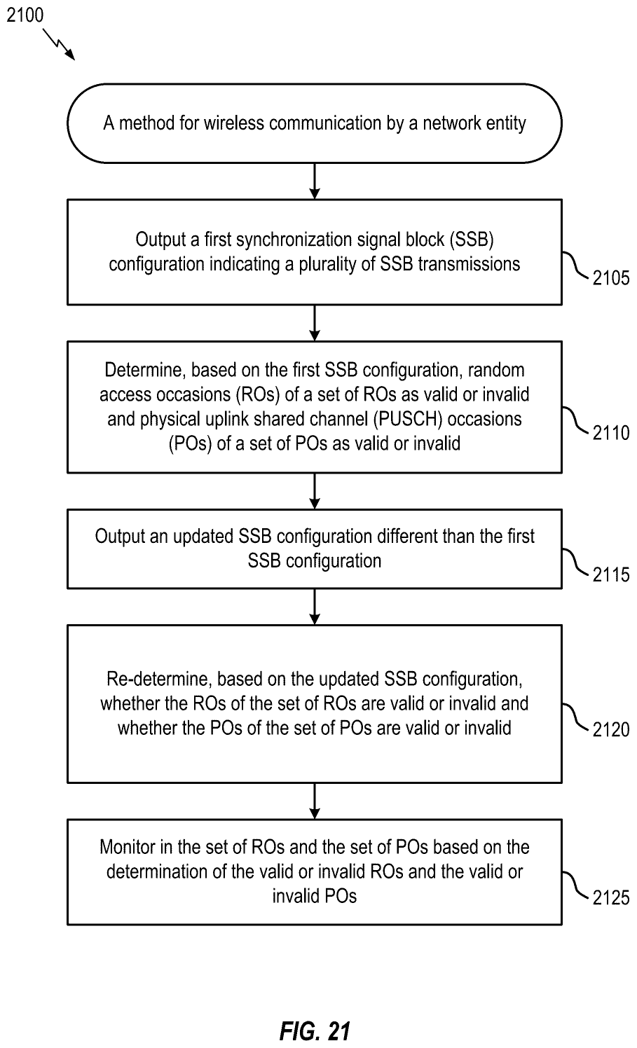

FIG. 21 shows an example of a method 2100 of wireless communication by a network entity, such as a BS 102 of FIGS. 1 and 3, or a disaggregated base station as discussed with respect to FIG. 2.

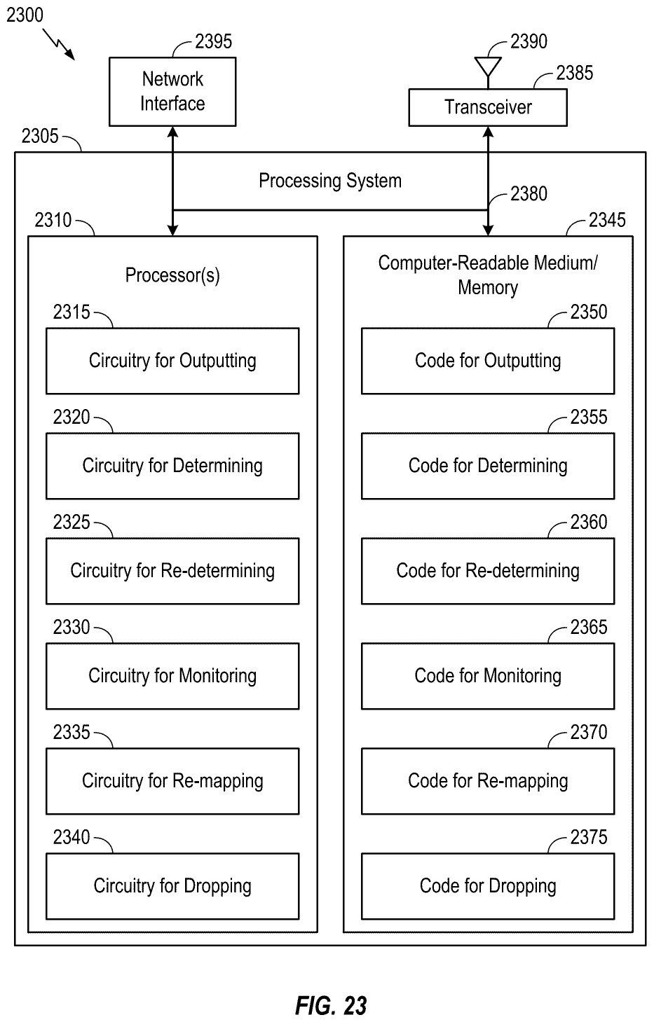

Method 2100 begins at step 2105 with outputting a first synchronization signal block (SSB) configuration indicating a plurality of SSB transmissions. In some cases, the operations of this step refer to, or may be performed by, circuitry for outputting and/or code for outputting as described with reference to FIG. 23.

Method 2100 then proceeds to step 2110 with determining, based on the first SSB configuration, random access occasions (ROs) of a set of ROs as valid or invalid and physical uplink shared channel (PUSCH) occasions (POs) of a set of POs as valid or invalid. In some cases, the operations of this step refer to, or may be performed by, circuitry for determining and/or code for determining as described with reference to FIG. 23.

Method 2100 then proceeds to step 2115 with outputting an updated SSB configuration different than the first SSB configuration. In some cases, the operations of this step refer to, or may be performed by, circuitry for outputting and/or code for outputting as described with reference to FIG. 23.

Method 2100 then proceeds to step 2120 with re-determining, based on the updated SSB configuration, whether the ROs of the set of ROs are valid or invalid and whether the POs of the set of POs are valid or invalid. In some cases, the operations of this step refer to, or may be performed by, circuitry for re-determining and/or code for re-determining as described with reference to FIG. 23.

Method 2100 then proceeds to step 2125 with monitoring in the set of ROs and the set of POs based on the determination of the valid or invalid ROs and the valid or invalid POs. In some cases, the operations of this step refer to, or may be performed by, circuitry for monitoring and/or code for monitoring as described with reference to FIG. 23.

In some aspects, determining, based on the first SSB configuration, whether the ROs of the set of ROs are valid or invalid and whether the POs of the set of POs are valid or invalid is further based on one or more configured rules for determining validity or invalidity of the ROs and POs.

In some aspects, determining, based on the first SSB configuration, the ROs of the set of ROs as valid or invalid and the POs of the set of POs as valid or invalid comprises: determining, based on the first SSB configuration, first overlap between one or more SSB transmissions of the plurality of SSB transmissions and at least one of: one or more ROs of the set of ROs or one or more POs of the set of POs; and determining, based on the first overlap and the one or more configured rules, the ROs of the set of ROs as valid or invalid and the POs of the set of POs as valid or invalid.

In some aspects, determining, based on the first overlap and the one or more configured rules, the ROs of the set of ROs as valid or invalid and the POs of the set of POs as valid or invalid comprises: determining a PO of the one or more POs of the set of POs as invalid when the PO precedes an SSB of the one or more SSBs transmissions in a PUSCH slot; determining a PO of the one or more POs of the set of POs as invalid when the PO starts within a preconfigured threshold number of symbols after a last symbol of an SSB of the one or more SSBs transmissions; and determining a PO of the one or more POs of the set of POs as valid when the PO does not precede an SSB of the one or more SSBs transmissions in a PUSCH slot and does not start within the preconfigured threshold number of symbols after the last symbol of the SSB of the one or more SSBs transmissions.

In some aspects, re-determining, based on the updated SSB configuration and the one or more configured rules, whether the ROs of the set of ROs are valid or invalid and whether the POs of the set of POs are valid or invalid comprises: determining, based on the updated SSB configuration, second overlap between one or more SSB transmissions of the plurality of SSB transmissions and at least one of: one or more ROs of the set of ROs or one or more POs of a set of POs, wherein the second overlap at least one of: includes overlap between one or more SSBs and at least one of: one or more ROs or one or more POs not included in the first overlap; or excludes overlap between one or more SSBs and at least one of: one or more ROs or one or more POs included in the first overlap; and determining, based on the second overlap and the one or more configured rules, at least one of: one or more of the valid ROs of the set of ROs as valid or invalid and one or more of the invalid ROs of the set of ROs as invalid or valid; and one or more of the valid POs of the set of POs as valid or invalid and one or more invalid POs of the set of POs as invalid or valid.

In some aspects, re-determining, based on the updated SSB configuration, whether the ROs of the set of ROs are valid or invalid comprises: re-determining an RO previously determined as invalid based on the first SSB configuration and the one or more configured rules as invalid, wherein the RO would be valid based on the updated SSB configuration and the one or more configured rules.

In some aspects, re-determining, based on the updated SSB configuration, whether the POs of the set of POs are valid or invalid comprises: re-determining a PO mapped to the RO as invalid, wherein the PO would be valid based on the updated SSB configuration and the one or more configured rules.

In some aspects, re-determining, based on the updated SSB configuration, whether the POs of the set of POs are valid or invalid comprises: re-determining a PO mapped to the invalid RO as valid.

In some aspects, the method 2100 further includes re-mapping the PO to a valid RO. In some cases, the operations of this step refer to, or may be performed by, circuitry for re-mapping and/or code for re-mapping as described with reference to FIG. 23.

In some aspects, re-determining, based on the updated SSB configuration, whether the ROs of the set of ROs are valid or invalid comprises: re-determining an RO previously determined as invalid based on the first SSB configuration and the one or more configured rules as valid, wherein the RO is valid based on the updated SSB configuration and the one or more configured rules.

In some aspects, re-determining, based on the updated SSB configuration, whether the POs of the set of POs are valid or invalid comprises: re-determining a PO mapped to the RO as valid.

In some aspects, re-determining, based on the updated SSB configuration, whether the ROs of the set of ROs are valid or invalid comprises: re-determining an RO previously determined as valid based on the first SSB configuration and the one or more configured rules as invalid, wherein the RO is invalid based on the updated SSB configuration and the one or more configured rules.

In some aspects, re-determining, based on the updated SSB configuration, whether the POs of the set of POs are valid or invalid comprises: re-determining a PO mapped to the RO as invalid.

In some aspects, re-determining, based on the updated SSB configuration, whether the POs of the set of POs are valid or invalid comprises: re-determining a PO mapped to the RO as valid.

In some aspects, re-determining, based on the updated SSB configuration, whether the ROs of the set of ROs are valid or invalid comprises: re-determining an RO previously determined as valid based on the first SSB configuration and the one or more configured rules as valid, wherein the RO would be invalid based on the updated SSB configuration and the one or more configured rules.

In some aspects, re-determining, based on the updated SSB configuration, whether the POs of the set of POs are valid or invalid comprises: re-determining a PO mapped to the RO as valid.

In some aspects, the method 2100 further includes dropping an SSB transmission in at least one of the RO or the PO redetermined as valid. In some cases, the operations of this step refer to, or may be performed by, circuitry for dropping and/or code for dropping as described with reference to FIG. 23.

In some aspects, re-determining, based on the updated SSB configuration, whether the POs of the set of POs are valid or invalid comprises: re-determining a PO previously determined as invalid based on the first SSB configuration and the one or more configured rules as invalid, wherein the PO would be valid based on the updated SSB configuration and the one or more configured rules.

In some aspects, re-determining, based on the updated SSB configuration, whether the ROs of the set of ROs are valid or invalid comprises: re-determining an RO mapped to the PO as valid, wherein the RO is valid based on both the first SSB configuration and the one or more configured rules and the updated SSB configuration and the one or more configured rules.

In some aspects, the method 2100 further includes re-mapping the valid RO to a valid PO. In some cases, the operations of this step refer to, or may be performed by, circuitry for re-mapping and/or code for re-mapping as described with reference to FIG. 23.

In some aspects, the method 2100 further includes monitoring an SSB transmission in at least one of the RO or the PO redetermined as valid. In some cases, the operations of this step refer to, or may be performed by, circuitry for monitoring and/or code for monitoring as described with reference to FIG. 23.

In some aspects, re-determining, based on the updated SSB configuration, whether the POs of the set of POs are valid or invalid comprises: re-determining a PO previously determined as invalid based on the first SSB configuration and the one or more configured rules as valid, wherein the PO would be valid based on the updated SSB configuration and the one or more configured rules.

In some aspects, re-determining, based on the updated SSB configuration, whether the POs of the set of POs are valid or invalid comprises: re-determining a PO previously determined as valid based on the first SSB configuration and the one or more configured rules as invalid, wherein the PO is invalid based on the updated SSB configuration and the one or more configured rules.

In some aspects, the method 2100 further includes re-mapping a valid RO, mapped to the invalid PO, to a valid PO. In some cases, the operations of this step refer to, or may be performed by, circuitry for re-mapping and/or code for re-mapping as described with reference to FIG. 23.

In some aspects, re-determining, based on the updated SSB configuration, whether the POs of the set of POs are valid or invalid comprises: re-determining a PO previously determined as valid based on the first SSB configuration and the one or more configured rules as valid, wherein the PO would be invalid based on the updated SSB configuration and the one or more configured rules.

In some aspects, monitoring in the set of ROs and the set of POs based on the determination of the valid or invalid ROs and the valid or invalid POs comprises: monitoring a random access preamble of a random access channel (RACH) message of a two-step RACH procedure in the valid ROs; and monitoring a PUSCH transmission of the RACH message of the two-step RACH procedure in the valid POs.

In some aspects, outputting the first SSB configuration comprises outputting the first SSB configuration in an initial system information block (SIB1) or in a radio resource control (RRC) reconfiguration message; and outputting the updated SSB configuration comprises outputting the updated SSB configuration before outputting a next SIB1 or RRC reconfiguration message.

In some aspects, the first SSB configuration indicates at least one of: a first SSB burst periodicity, a first number of SSBs within the SSB burst, a first cell discontinuous transmission (DRX) configuration for SSB transmission, a first SSB burst skipping configuration, or a first location of SSBs within the SSB burst; and the updated SSB configuration indicates at least one of: a second SSB burst periodicity, a second number of SSBs within the SSB burst, a second cell DTX configuration for SSB transmission, a second SSB burst skipping configuration, or a second location of SSBs within the SSB burst.

In one aspect, method 2100, or any aspect related to it, may be performed by an apparatus, such as communications device 2300 of FIG. 23, which includes various components operable, configured, or adapted to perform the method 2100. Communications device 2300 is described below in further detail.

Note that FIG. 21 is just one example of a method, and other methods including fewer, additional, or alternative steps are possible consistent with this disclosure.

### Example Communications Device(s)

FIG. 22 depicts aspects of an example communications device 2200. In some aspects, communications device 2200 is a user equipment, such as UE 104 described above with respect to FIGS. 1 and 3.

The communications device 2200 includes a processing system 2205 coupled to the transceiver 2275 (e.g., a transmitter and/or a receiver). The transceiver 2275 is configured to transmit and receive signals for the communications device 2200 via the antenna 2280, such as the various signals as described herein. The processing system 2205 may be configured to perform processing functions for the communications device 2200, including processing signals received and/or to be transmitted by the communications device 2200.

The processing system 2205 includes one or more processors 2210. In various aspects, the one or more processors 2210 may be representative of one or more of receive processor 358, transmit processor 364, TX MIMO processor 366, and/or controller/processor 380, as described with respect to FIG. 3. The one or more processors 2210 are coupled to a computer-readable medium/memory 2240 via a bus 2270. In certain aspects, the computer-readable medium/memory 2240 is configured to store instructions (e.g., computer-executable code) that when executed by the one or more processors 2210, cause the one or more processors 2210 to perform the method 2000 described with respect to FIG. 20, or any aspect related to it. Note that reference to a processor performing a function of communications device 2200 may include one or more processors 2210 performing that function of communications device 2200.

In the depicted example, computer-readable medium/memory 2240 stores code (e.g., executable instructions), such as code for receiving 2245, code for determining 2250, code for re-determining 2255, code for transmitting 2260, and code for re-mapping 2265. Processing of the code for receiving 2245, code for determining 2250, code for re-determining 2255, code for transmitting 2260, and code for re-mapping 2265 may cause the communications device 2200 to perform the method 2000 described with respect to FIG. 20, or any aspect related to it.

The one or more processors 2210 include circuitry configured to implement (e.g., execute) the code stored in the computer-readable medium/memory 2240, including circuitry such as circuitry for receiving 2215, circuitry for determining 2220, circuitry for re-determining 2225, circuitry for transmitting 2230, and circuitry for re-mapping 2235. Processing with circuitry for receiving 2215, circuitry for determining 2220, circuitry for re-determining 2225, circuitry for transmitting 2230, and circuitry for re-mapping 2235 may cause the communications device 2200 to perform the method 2000 described with respect to FIG. 20, or any aspect related to it.

Various components of the communications device 2200 may provide means for performing the method 2000 described with respect to FIG. 20, or any aspect related to it. For example, means for transmitting, sending or outputting for transmission may include transceivers 354 and/or antenna(s) 352 of the UE 104 illustrated in FIG. 3 and/or the transceiver 2275 and the antenna 2280 of the communications device 2200 in FIG. 22. Means for receiving or obtaining may include transceivers 354 and/or antenna(s) 352 of the UE 104 illustrated in FIG. 3 and/or the transceiver 2275 and the antenna 2280 of the communications device 2200 in FIG. 22.

FIG. 23 depicts aspects of an example communications device 2300. In some aspects, communications device 2300 is a network entity, such as BS 102 of FIGS. 1 and 3, or a disaggregated base station as discussed with respect to FIG. 2.

The communications device 2300 includes a processing system 2305 coupled to the transceiver 2385 (e.g., a transmitter and/or a receiver) and/or a network interface 2395. The transceiver 2385 is configured to transmit and receive signals for the communications device 2300 via the antenna 2390, such as the various signals as described herein. The network interface 2395 is configured to obtain and send signals for the communications device 2300 via communication link(s), such as a backhaul link, midhaul link, and/or fronthaul link as described herein, such as with respect to FIG. 2. The processing system 2305 may be configured to perform processing functions for the communications device 2300, including processing signals received and/or to be transmitted by the communications device 2300.

The processing system 2305 includes one or more processors 2310. In various aspects, one or more processors 2310 may be representative of one or more of receive processor 338, transmit processor 320, TX MIMO processor 330, and/or controller/processor 340, as described with respect to FIG. 3. The one or more processors 2310 are coupled to a computer-readable medium/memory 2345 via a bus 2380. In certain aspects, the computer-readable medium/memory 2345 is configured to store instructions (e.g., computer-executable code) that when executed by the one or more processors 2310, cause the one or more processors 2310 to perform the method 2100 described with respect to FIG. 21, or any aspect related to it. Note that reference to a processor of communications device 2300 performing a function may include one or more processors 2310 of communications device 2300 performing that function.

In the depicted example, the computer-readable medium/memory 2345 stores code (e.g., executable instructions), such as code for outputting 2350, code for determining 2355, code for re-determining 2360, code for monitoring 2365, code for re-mapping 2370, and code for dropping 2375. Processing of the code for outputting 2350, code for determining 2355, code for re-determining 2360, code for monitoring 2365, code for re-mapping 2370, and code for dropping 2375 may cause the communications device 2300 to perform the method 2100 described with respect to FIG. 21, or any aspect related to it.

The one or more processors 2310 include circuitry configured to implement (e.g., execute) the code stored in the computer-readable medium/memory 2345, including circuitry such as circuitry for outputting 2315, circuitry for determining 2320, circuitry for re-determining 2325, circuitry for monitoring 2330, circuitry for re-mapping 2335, and circuitry for dropping 2340. Processing with circuitry for outputting 2315, circuitry for determining 2320, circuitry for re-determining 2325, circuitry for monitoring 2330, circuitry for re-mapping 2335, and circuitry for dropping 2340 may cause the communications device 2300 to perform the method 2100 described with respect to FIG. 21, or any aspect related to it.

Various components of the communications device 2300 may provide means for performing the method 2100 described with respect to FIG. 21, or any aspect related to it. Means for transmitting, sending or outputting for transmission may include transceivers 332 and/or antenna(s) 334 of the BS 102 illustrated in FIG. 3 and/or the transceiver 2385 and the antenna 2390 of the communications device 2300 in FIG. 23. Means for receiving or obtaining may include transceivers 332 and/or antenna(s) 334 of the BS 102 illustrated in FIG. 3 and/or the transceiver 2385 and the antenna 2390 of the communications device 2300 in FIG. 23.

### Example Clauses

Implementation examples are described in the following numbered clauses:

Clause 1: A method for wireless communication by a user equipment (UE), comprising: receiving a first synchronization signal block (SSB) configuration indicating a plurality of SSB transmissions; determining, based on the first SSB configuration, random access occasions (ROs) of a set of ROs as valid or invalid and physical uplink shared channel (PUSCH) occasions (POs) of a set of POs as valid or invalid; receiving an updated SSB configuration different than the first SSB configuration; re-determining, based on the updated SSB configuration, whether the ROs of the set of ROs are valid or invalid and whether the POs of the set of POs are valid or invalid; and transmitting in the set of ROs and the set of POs based on the determination of the valid or invalid ROs and the valid or invalid POs.

Clause 2: The method of Clause 1, wherein determining, based on the first SSB configuration, whether the ROs of the set of ROs are valid or invalid and whether the POs of the set of POs are valid or invalid is further based on one or more configured rules for determining validity or invalidity of the ROs and POs.

Clause 3: The method of Clause 2, wherein determining, based on the first SSB configuration, the ROs of the set of ROs as valid or invalid and the POs of the set of POs as valid or invalid comprises: determining, based on the first SSB configuration, first overlap between one or more SSB transmissions of the plurality of SSB transmissions and at least one of: one or more ROs of the set of ROs or one or more POs of the set of POs; and determining, based on the first overlap and the one or more configured rules, the ROs of the set of ROs as valid or invalid and the POs of the set of POs as valid or invalid.

Clause 4: The method of Clause 3, wherein determining, based on the first overlap and the one or more configured rules, the ROs of the set of ROs as valid or invalid and the POs of the set of POs as valid or invalid comprises: determining a PO of the one or more POs of the set of POs as invalid when the PO precedes an SSB of the one or more SSBs transmissions in a PUSCH slot; determining a PO of the one or more POs of the set of POs as invalid when the PO starts within a preconfigured threshold number of symbols after a last symbol of an SSB of the one or more SSBs transmissions; and determining a PO of the one or more POs of the set of POs as valid when the PO does not precede an SSB of the one or more SSBs transmissions in a PUSCH slot and does not start within the preconfigured threshold number of symbols after the last symbol of the SSB of the one or more SSBs transmissions.

Clause 5: The method of any combination of Clauses 3-4, wherein re-determining, based on the updated SSB configuration and the one or more configured rules, whether the ROs of the set of ROs are valid or invalid and whether the POs of the set of POs are valid or invalid comprises: determining, based on the updated SSB configuration, second overlap between one or more SSB transmissions of the plurality of SSB transmissions and at least one of: one or more ROs of the set of ROs or one or more POs of a set of POs, wherein the second overlap at least one of: includes overlap between one or more SSBs and at least one of: one or more ROs or one or more POs not included in the first overlap; or excludes overlap between one or more SSBs and at least one of: one or more ROs or one or more POs included in the first overlap; and determining, based on the second overlap and the one or more configured rules, at least one of: one or more of the valid ROs of the set of ROs as valid or invalid and one or more of the invalid ROs of the set of ROs as invalid or valid; and one or more of the valid POs of the set of POs as valid or invalid and one or more invalid POs of the set of POs as invalid or valid.

Clause 6: The method of any combination of Clauses 2-5, wherein re-determining, based on the updated SSB configuration, whether the ROs of the set of ROs are valid or invalid comprises: re-determining an RO previously determined as invalid based on the first SSB configuration and the one or more configured rules as invalid, wherein the RO would be valid based on the updated SSB configuration and the one or more configured rules.

Clause 7: The method of Clause 6, wherein re-determining, based on the updated SSB configuration, whether the POs of the set of POs are valid or invalid comprises: re-determining a PO mapped to the RO as invalid, wherein the PO would be valid based on the updated SSB configuration and the one or more configured rules.

Clause 8: The method of Clause 6, wherein re-determining, based on the updated SSB configuration, whether the POs of the set of POs are valid or invalid comprises: re-determining a PO mapped to the invalid RO as valid.

Clause 9: The method of Clause 8, further comprising re-mapping the PO to a valid RO.

Clause 10: The method of any combination of Clauses 2-9, wherein re-determining, based on the updated SSB configuration, whether the ROs of the set of ROs are valid or invalid comprises: re-determining an RO previously determined as invalid based on the first SSB configuration and the one or more configured rules as valid, wherein the RO is valid based on the updated SSB configuration and the one or more configured rules.

Clause 11: The method of Clause 10, wherein re-determining, based on the updated SSB configuration, whether the POs of the set of POs are valid or invalid comprises: re-determining a PO mapped to the RO as valid.

Clause 12: The method of any combination of Clauses 2-11, wherein re-determining, based on the updated SSB configuration, whether the ROs of the set of ROs are valid or invalid comprises: re-determining an RO previously determined as valid based on the first SSB configuration and the one or more configured rules as invalid, wherein the RO is invalid based on the updated SSB configuration and the one or more configured rules.

Clause 13: The method of Clause 12, wherein re-determining, based on the updated SSB configuration, whether the POs of the set of POs are valid or invalid comprises: re-determining a PO mapped to the RO as invalid.

Clause 14: The method of Clause 12, wherein re-determining, based on the updated SSB configuration, whether the POs of the set of POs are valid or invalid comprises: re-determining a PO mapped to the RO as valid.

Clause 15: The method of any combination of Clauses 2-14, wherein re-determining, based on the updated SSB configuration, whether the ROs of the set of ROs are valid or invalid comprises: re-determining an RO previously determined as valid based on the first SSB configuration and the one or more configured rules as valid, wherein the RO would be invalid based on the updated SSB configuration and the one or more configured rules.

Clause 16: The method of Clause 15, wherein re-determining, based on the updated SSB configuration, whether the POs of the set of POs are valid or invalid comprises: re-determining a PO mapped to the RO as valid.

Clause 17: The method of any combination of Clauses 2-16, wherein re-determining, based on the updated SSB configuration, whether the POs of the set of POs are valid or invalid comprises: re-determining a PO previously determined as invalid based on the first SSB configuration and the one or more configured rules as invalid, wherein the PO would be valid based on the updated SSB configuration and the one or more configured rules.

Clause 18: The method of Clause 17, wherein re-determining, based on the updated SSB configuration, whether the ROs of the set of ROs are valid or invalid comprises: re-determining an RO mapped to the PO as valid, wherein the RO is valid based on both the first SSB configuration and the one or more configured rules and the updated SSB configuration and the one or more configured rules.

Clause 19: The method of Clause 18, further comprising re-mapping the valid RO to a valid PO.

Clause 20: The method of any combination of Clauses 2-19, wherein re-determining, based on the updated SSB configuration, whether the POs of the set of POs are valid or invalid comprises: re-determining a PO previously determined as invalid based on the first SSB configuration and the one or more configured rules as valid, wherein the PO would be valid based on the updated SSB configuration and the one or more configured rules.

Clause 21: The method of any combination of Clauses 2-20, wherein re-determining, based on the updated SSB configuration, whether the POs of the set of POs are valid or invalid comprises: re-determining a PO previously determined as valid based on the first SSB configuration and the one or more configured rules as invalid, wherein the PO is invalid based on the updated SSB configuration and the one or more configured rules.

Clause 22: The method of Clause 21, further comprising re-mapping a valid RO, mapped to the invalid PO, to a valid PO.

Clause 23: The method of any combination of Clauses 2-22, wherein re-determining, based on the updated SSB configuration, whether the POs of the set of POs are valid or invalid comprises: re-determining a PO previously determined as valid based on the first SSB configuration and the one or more configured rules as valid, wherein the PO would be invalid based on the updated SSB configuration and the one or more configured rules.

Clause 24: The method of any combination of Clauses 1-23, wherein transmitting in the set of ROs and the set of POs based on the determination of the valid or invalid ROs and the valid or invalid POs comprises: transmitting a random access preamble of a random access channel (RACH) message of a two-step RACH procedure in the valid ROs; and transmitting a PUSCH transmission of the RACH message of the two-step RACH procedure in the valid POs.

Clause 25: The method of any combination of Clauses 1-24, wherein: receiving the first SSB configuration comprises receiving the first SSB configuration in an initial system information block (SIB1) or in a radio resource control (RRC) reconfiguration message; and receiving the updated SSB configuration comprises receiving the updated SSB configuration before receiving a next SIB1 or RRC reconfiguration message.

Clause 26: The method of any combination of Clauses 1-25, wherein: the first SSB configuration indicates at least one of: a first SSB burst periodicity, a first number of SSBs within the SSB burst, a first cell discontinuous transmission (DRX) configuration for SSB transmission, a first SSB burst skipping configuration, or a first location of SSBs within the SSB burst; and the updated SSB configuration indicates at least one of: a second SSB burst periodicity, a second number of SSBs within the SSB burst, a second cell DTX configuration for SSB transmission, a second SSB burst skipping configuration, or a second location of SSBs within the SSB burst.

Clause 27: A method for wireless communication by a network entity, comprising: outputting a first synchronization signal block (SSB) configuration indicating a plurality of SSB transmissions; determining, based on the first SSB configuration, random access occasions (ROs) of a set of ROs as valid or invalid and physical uplink shared channel (PUSCH) occasions (POs) of a set of POs as valid or invalid; outputting an updated SSB configuration different than the first SSB configuration; re-determining, based on the updated SSB configuration, whether the ROs of the set of ROs are valid or invalid and whether the POs of the set of POs are valid or invalid; and monitoring in the set of ROs and the set of POs based on the determination of the valid or invalid ROs and the valid or invalid POs.

Clause 28: The method of Clause 27, wherein determining, based on the first SSB configuration, whether the ROs of the set of ROs are valid or invalid and whether the POs of the set of POs are valid or invalid is further based on one or more configured rules for determining validity or invalidity of the ROs and POs.

Clause 29: The method of Clause 28, wherein determining, based on the first SSB configuration, the ROs of the set of ROs as valid or invalid and the POs of the set of POs as valid or invalid comprises: determining, based on the first SSB configuration, first overlap between one or more SSB transmissions of the plurality of SSB transmissions and at least one of: one or more ROs of the set of ROs or one or more POs of the set of POs; and determining, based on the first overlap and the one or more configured rules, the ROs of the set of ROs as valid or invalid and the POs of the set of POs as valid or invalid.

Clause 30: The method of Clause 29, wherein determining, based on the first overlap and the one or more configured rules, the ROs of the set of ROs as valid or invalid and the POs of the set of POs as valid or invalid comprises: determining a PO of the one or more POs of the set of POs as invalid when the PO precedes an SSB of the one or more SSBs transmissions in a PUSCH slot; determining a PO of the one or more POs of the set of POs as invalid when the PO starts within a preconfigured threshold number of symbols after a last symbol of an SSB of the one or more SSBs transmissions; and determining a PO of the one or more POs of the set of POs as valid when the PO does not precede an SSB of the one or more SSBs transmissions in a PUSCH slot and does not start within the preconfigured threshold number of symbols after the last symbol of the SSB of the one or more SSBs transmissions.

Clause 31: The method of any combination of Clauses 29-30, wherein re-determining, based on the updated SSB configuration and the one or more configured rules, whether the ROs of the set of ROs are valid or invalid and whether the POs of the set of POs are valid or invalid comprises: determining, based on the updated SSB configuration, second overlap between one or more SSB transmissions of the plurality of SSB transmissions and at least one of: one or more ROs of the set of ROs or one or more POs of a set of POs, wherein the second overlap at least one of: includes overlap between one or more SSBs and at least one of: one or more ROs or one or more POs not included in the first overlap; or excludes overlap between one or more SSBs and at least one of: one or more ROs or one or more POs included in the first overlap; and determining, based on the second overlap and the one or more configured rules, at least one of: one or more of the valid ROs of the set of ROs as valid or invalid and one or more of the invalid ROs of the set of ROs as invalid or valid; and one or more of the valid POs of the set of POs as valid or invalid and one or more invalid POs of the set of POs as invalid or valid.

Clause 32: The method of any combination of Clauses 28-31, wherein re-determining, based on the updated SSB configuration, whether the ROs of the set of ROs are valid or invalid comprises: re-determining an RO previously determined as invalid based on the first SSB configuration and the one or more configured rules as invalid, wherein the RO would be valid based on the updated SSB configuration and the one or more configured rules.

Clause 33: The method of Clause 32, wherein re-determining, based on the updated SSB configuration, whether the POs of the set of POs are valid or invalid comprises: re-determining a PO mapped to the RO as invalid, wherein the PO would be valid based on the updated SSB configuration and the one or more configured rules.

Clause 34: The method of any combination of Clauses 32-33, wherein re-determining, based on the updated SSB configuration, whether the POs of the set of POs are valid or invalid comprises: re-determining a PO mapped to the invalid RO as valid.

Clause 35: The method of Clause 34, further comprising re-mapping the PO to a valid RO.

Clause 36: The method of any combination of Clauses 28-35, wherein re-determining, based on the updated SSB configuration, whether the ROs of the set of ROs are valid or invalid comprises: re-determining an RO previously determined as invalid based on the first SSB configuration and the one or more configured rules as valid, wherein the RO is valid based on the updated SSB configuration and the one or more configured rules.

Clause 37: The method of Clause 36, wherein re-determining, based on the updated SSB configuration, whether the POs of the set of POs are valid or invalid comprises: re-determining a PO mapped to the RO as valid.

Clause 38: The method of any combination of Clauses 28-37, wherein re-determining, based on the updated SSB configuration, whether the ROs of the set of ROs are valid or invalid comprises: re-determining an RO previously determined as valid based on the first SSB configuration and the one or more configured rules as invalid, wherein the RO is invalid based on the updated SSB configuration and the one or more configured rules.

Clause 39: The method of Clause 38, wherein re-determining, based on the updated SSB configuration, whether the POs of the set of POs are valid or invalid comprises: re-determining a PO mapped to the RO as invalid.

Clause 40: The method of Clause 38, wherein re-determining, based on the updated SSB configuration, whether the POs of the set of POs are valid or invalid comprises: re-determining a PO mapped to the RO as valid.

Clause 41: The method of any combination of Clauses 28-40, wherein re-determining, based on the updated SSB configuration, whether the ROs of the set of ROs are valid or invalid comprises: re-determining an RO previously determined as valid based on the first SSB configuration and the one or more configured rules as valid, wherein the RO would be invalid based on the updated SSB configuration and the one or more configured rules.

Clause 42: The method of Clause 41, wherein re-determining, based on the updated SSB configuration, whether the POs of the set of POs are valid or invalid comprises: re-determining a PO mapped to the RO as valid.

Clause 43: The method of Clause 42, further comprising dropping an SSB transmission in at least one of the RO or the PO redetermined as valid.

Clause 44: The method of any combination of Clauses 28-44, wherein re-determining, based on the updated SSB configuration, whether the POs of the set of POs are valid or invalid comprises: re-determining a PO previously determined as invalid based on the first SSB configuration and the one or more configured rules as invalid, wherein the PO would be valid based on the updated SSB configuration and the one or more configured rules.

Clause 45: The method of Clause 44, wherein re-determining, based on the updated SSB configuration, whether the ROs of the set of ROs are valid or invalid comprises: re-determining an RO mapped to the PO as valid, wherein the RO is valid based on both the first SSB configuration and the one or more configured rules and the updated SSB configuration and the one or more configured rules.

Clause 46: The method of Clause 45, further comprising re-mapping the valid RO to a valid PO.

Clause 47: The method of any combination of Clauses 45-46, further comprising monitoring an SSB transmission in at least one of the RO or the PO redetermined as valid.

Clause 48: The method of any combination of Clauses 28-48, wherein re-determining, based on the updated SSB configuration, whether the POs of the set of POs are valid or invalid comprises: re-determining a PO previously determined as invalid based on the first SSB configuration and the one or more configured rules as valid, wherein the PO would be valid based on the updated SSB configuration and the one or more configured rules.

Clause 49: The method of any combination of Clauses 28-48, wherein re-determining, based on the updated SSB configuration, whether the POs of the set of POs are valid or invalid comprises: re-determining a PO previously determined as valid based on the first SSB configuration and the one or more configured rules as invalid, wherein the PO is invalid based on the updated SSB configuration and the one or more configured rules.

Clause 50: The method of Clause 49, further comprising re-mapping a valid RO, mapped to the invalid PO, to a valid PO.

Clause 51: The method of any combination of Clauses 28-50, wherein re-determining, based on the updated SSB configuration, whether the POs of the set of POs are valid or invalid comprises: re-determining a PO previously determined as valid based on the first SSB configuration and the one or more configured rules as valid, wherein the PO would be invalid based on the updated SSB configuration and the one or more configured rules.

Clause 52: The method of any combination of Clauses 27-51, wherein monitoring in the set of ROs and the set of POs based on the determination of the valid or invalid ROs and the valid or invalid POs comprises: monitoring a random access preamble of a random access channel (RACH) message of a two-step RACH procedure in the valid ROs; and monitoring a PUSCH transmission of the RACH message of the two-step RACH procedure in the valid POs.

Clause 53: The method of any combination of Clauses 27-52, wherein: outputting the first SSB configuration comprises outputting the first SSB configuration in an initial system information block (SIB1) or in a radio resource control (RRC) reconfiguration message; and outputting the updated SSB configuration comprises outputting the updated SSB configuration before outputting a next SIB1 or RRC reconfiguration message.

Clause 54: The method of any combination of Clauses 27-53, wherein: the first SSB configuration indicates at least one of: a first SSB burst periodicity, a first number of SSBs within the SSB burst, a first cell discontinuous transmission (DRX) configuration for SSB transmission, a first SSB burst skipping configuration, or a first location of SSBs within the SSB burst; and the updated SSB configuration indicates at least one of: a second SSB burst periodicity, a second number of SSBs within the SSB burst, a second cell DTX configuration for SSB transmission, a second SSB burst skipping configuration, or a second location of SSBs within the SSB burst.

Clause 55: An apparatus, comprising: at least one memory comprising executable instructions; and at least one processor configured to execute the executable instructions and cause the apparatus to perform a method in accordance with any combination of Clauses 1-54.

Clause 56: An apparatus, comprising means for performing a method in accordance with any combination of Clauses 1-54.

Clause 57: A non-transitory computer-readable medium comprising executable instructions that, when executed by at least one processor of an apparatus, cause the apparatus to perform a method in accordance with any combination of Clauses 1-54.

Clause 58: A computer program product embodied on a computer-readable storage medium comprising code for performing a method in accordance with any combination of Clauses 1-54.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a graphics processing unit (GPU), a neural processing unit (NPU), a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

In some cases, rather than actually transmitting a signal, an apparatus (e.g., a wireless node or device) may have an interface to output the signal for transmission. For example, a processor may output a signal, via a bus interface, to a radio frequency (RF) front end for transmission. Accordingly, a means for outputting may include such an interface as an alternative (or in addition) to a transmitter or transceiver. Similarly, rather than actually receiving a signal, an apparatus (e.g., a wireless node or device) may have an interface to obtain a signal from another device. For example, a processor may obtain (or receive) a signal, via a bus interface, from an RF front end for reception. Accordingly, a means for obtaining may include such an interface as an alternative (or in addition) to a receiver or transceiver.

While the present disclosure may describe certain operations as being performed by one type of wireless node, the same or similar operations may also be performed by another type of wireless node. For example, operations performed by a user equipment (UE) may also (or instead) be performed by a network entity (e.g., a base station or unit of a disaggregated base station). Similarly, operations performed by a network entity may also (or instead) be performed by a UE.

Further, while the present disclosure may describe certain types of communications between different types of wireless nodes (e.g., between a network entity and a UE), the same or similar types of communications may occur between same types of wireless nodes (e.g., between network entities or between UEs, in a peer-to-peer scenario). Further, communications may occur in reverse order than described.

Means for receiving, means for determining, means for re-determining, means for transmitting, means for re-mapping, means for outputting, and means for monitoring may comprise one or more processors, such as one or more of the processors described above with reference to FIG. 22, and FIG. 23.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining”may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A user equipment configured for wireless communications, the user equipment comprising:
a memory comprising computer-executable instructions; and
one or more processors configured to execute the computer-executable instructions and cause the user equipment to:
receive a first synchronization signal block (SSB) configuration indicating a plurality of SSB transmissions;
determine, based on the first SSB configuration, random access occasions (ROs) of a set of ROs as valid or invalid and physical uplink shared channel (PUSCH) occasions (POs) of a set of POs as valid or invalid;
receive an updated SSB configuration different than the first SSB configuration;
re-determine, based on the updated SSB configuration, whether the ROs of the set of ROs are valid or invalid and whether the POs of the set of POs are valid or invalid; and
transmit in the set of ROs and the set of POs based on the determination of the valid or invalid ROs and the valid or invalid POs.

2. The user equipment of claim 1, wherein one or more processors are configured to cause the user equipment to determining, based on the first SSB configuration, whether the ROs of the set of ROs are valid or invalid and whether the POs of the set of POs are valid or invalid further based on one or more configured rules for determining validity or invalidity of the ROs and POs.

3. The user equipment of claim 2, wherein one or more processors are configured to cause the user equipment to:
determine, based on the first SSB configuration, first overlap between one or more SSB transmissions of the plurality of SSB transmissions and at least one of: one or more ROs of the set of ROs or one or more POs of the set of POs; and
determine, based on the first overlap and the one or more configured rules, the ROs of the set of ROs as valid or invalid and the POs of the set of POs as valid or invalid.

4. The user equipment of claim 3, wherein one or more processors are configured to cause the user equipment to:
determine a PO of the one or more POs of the set of POs as invalid when the PO precedes an SSB of the one or more SSBs transmissions in a PUSCH slot;
determine a PO of the one or more POs of the set of POs as invalid when the PO starts within a preconfigured threshold number of symbols after a last symbol of an SSB of the one or more SSBs transmissions; and
determine a PO of the one or more POs of the set of POs as valid when the PO does not precede an SSB of the one or more SSBs transmissions in a PUSCH slot and does not start within the preconfigured threshold number of symbols after the last symbol of the SSB of the one or more SSBs transmissions.

5. The user equipment of claim 3, wherein the one or more processors are configured to cause the user equipment to:
determine, based on the updated SSB configuration, a second overlap between one or more SSB transmissions of the plurality of SSB transmissions and at least one of: one or more ROs of the set of ROs or one or more POs of a set of POs, wherein the second overlap at least one of:
includes overlap between one or more SSBs and at least one of: one or more ROs or one or more POs not included in the first overlap; or
excludes overlap between one or more SSBs and at least one of: one or more ROs or one or more POs included in the first overlap; and
determine, based on the second overlap and the one or more configured rules, at least one of:
one or more of the valid ROs of the set of ROs as valid or invalid and
one or more of the invalid ROs of the set of ROs as invalid or valid; and
one or more of the valid POs of the set of POs as valid or invalid and one or more invalid POs of the set of POs as invalid or valid.

6. The user equipment of claim 2, wherein the one or more processors are configured to cause the user equipment to:
re-determine an RO previously determined as invalid based on the first SSB configuration and the one or more configured rules as invalid, wherein the RO would be valid based on the updated SSB configuration and the one or more configured rules.

7. The user equipment of claim 6, wherein one or more processors are configured to cause the user equipment to:
re-determine a PO mapped to the RO as invalid, wherein the PO would be valid based on the updated SSB configuration and the one or more configured rules.

8. The user equipment of claim 6, wherein one or more processors are configured to cause the user equipment to:
re-determine a PO mapped to the invalid RO as valid.

9. The user equipment of claim 8, wherein one or more processors are configured to cause the user equipment further to re-map the PO to a valid RO.

10. The user equipment of claim 2, wherein one or more processors are configured to cause the user equipment to:
re-determine an RO previously determined as invalid based on the first SSB configuration and the one or more configured rules as valid, wherein the RO is valid based on the updated SSB configuration and the one or more configured rules.

11. The user equipment of claim 10, wherein one or more processors are configured to cause the user equipment to:
re-determine a PO mapped to the RO as valid.

12. The user equipment of claim 2, wherein one or more processors are configured to cause the user equipment to:
re-determine an RO previously determined as valid based on the first SSB configuration and the one or more configured rules as invalid, wherein the RO is invalid based on the updated SSB configuration and the one or more configured rules.

13. The user equipment of claim 12, wherein one or more processors are configured to cause the user equipment to:
re-determine a PO mapped to the RO as invalid.

14. The user equipment of claim 12, wherein one or more processors are configured to cause the user equipment to:
re-determine a PO mapped to the RO as valid.

15. The user equipment of claim 2, wherein one or more processors are configured to cause the user equipment to:
re-determine an RO previously determined as valid based on the first SSB configuration and the one or more configured rules as valid, wherein the RO would be invalid based on the updated SSB configuration and the one or more configured rules.

16. The user equipment of claim 15, wherein one or more processors are configured to cause the user equipment to:
re-determine a PO mapped to the RO as valid.

17. The user equipment of claim 2, wherein one or more processors are configured to cause the user equipment to:
re-determine a PO previously determined as invalid based on the first SSB configuration and the one or more configured rules as invalid, wherein the PO would be valid based on the updated SSB configuration and the one or more configured rules.

18. The user equipment of claim 17, wherein one or more processors are configured to cause the user equipment to:
re-determine an RO mapped to the PO as valid, wherein the RO is valid based on both the first SSB configuration and the one or more configured rules and the updated SSB configuration and the one or more configured rules.

19. The user equipment of claim 18, wherein one or more processors are configured to cause the user equipment further to re-map the valid RO to a valid PO.

20. The user equipment of claim 2, wherein one or more processors are configured to cause the user equipment to:
re-determine a PO previously determined as invalid based on the first SSB configuration and the one or more configured rules as valid, wherein the PO would be valid based on the updated SSB configuration and the one or more configured rules.

21. The user equipment of claim 2, wherein one or more processors are configured to cause the user equipment to:
re-determine a PO previously determined as valid based on the first SSB configuration and the one or more configured rules as invalid, wherein the PO is invalid based on the updated SSB configuration and the one or more configured rules.

22. The user equipment of claim 21, wherein one or more processors are configured to cause the user equipment further to re-map a valid RO, mapped to the invalid PO, to a valid PO.

23. The user equipment of claim 2, wherein one or more processors are configured to cause the user equipment to:
re-determine a PO previously determined as valid based on the first SSB configuration and the one or more configured rules as valid, wherein the PO would be invalid based on the updated SSB configuration and the one or more configured rules.

24. The user equipment of claim 1, wherein one or more processors are configured to cause the user equipment to:
transmit a random access preamble of a random access channel (RACH) message of a two-step RACH procedure in the valid ROs; and
transmit a PUSCH transmission of the RACH message of the two-step RACH procedure in the valid POs.

25. The user equipment of claim 1, wherein one or more processors are configured to cause the user equipment to:
receive the first SSB configuration in an initial system information block (SIB1) or in a radio resource control (RRC) reconfiguration message; and
receive the updated SSB configuration before receiving a next SIB1 or RRC reconfiguration message.

26. The user equipment of claim 1, wherein:
the first SSB configuration indicates at least one of: a first SSB burst periodicity, a first number of SSBs within the SSB burst, a first cell discontinuous transmission (DRX) configuration for SSB transmission, a first SSB burst skipping configuration, or a first location of SSBs within the SSB burst; and
the updated SSB configuration indicates at least one of: a second SSB burst periodicity, a second number of SSBs within the SSB burst, a second cell DTX configuration for SSB transmission, a second SSB burst skipping configuration, or a second location of SSBs within the SSB burst.

27. A network entity, comprising:
a memory comprising computer-executable instructions; and
one or more processors configured to execute the computer-executable instructions and cause the network entity to:
output a first synchronization signal block (SSB) configuration indicating a plurality of SSB transmissions;
determine, based on the first SSB configuration, random access occasions (ROs) of a set of ROs as valid or invalid and physical uplink shared channel (PUSCH) occasions (POs) of a set of POs as valid or invalid;
output an updated SSB configuration different than the first SSB configuration;
re-determine, based on the updated SSB configuration, whether the ROs of the set of ROs are valid or invalid and whether the POs of the set of POs are valid or invalid; and
monitor in the set of ROs and the set of POs based on the determination of the valid or invalid ROs and the valid or invalid POs.

28. A method for wireless communication by a user equipment (UE), the method comprising:
receiving a first synchronization signal block (SSB) configuration indicating a plurality of SSB transmissions;
determining, based on the first SSB configuration, random access occasions (ROs) of a set of ROs as valid or invalid and physical uplink shared channel (PUSCH) occasions (POs) of a set of POs as valid or invalid;
receiving an updated SSB configuration different than the first SSB configuration;
re-determining, based on the updated SSB configuration, whether the ROs of the set of ROs are valid or invalid and whether the POs of the set of POs are valid or invalid; and
transmitting in the set of ROs and the set of POs based on the determination of the valid or invalid ROs and the valid or invalid POs.

29. A method for wireless communication by a user equipment (UE), the method comprising:
outputting a first synchronization signal block (SSB) configuration indicating a plurality of SSB transmissions;
determining, based on the first SSB configuration, random access occasions (ROs) of a set of ROs as valid or invalid and physical uplink shared channel (PUSCH) occasions (POs) of a set of POs as valid or invalid;
outputting an updated SSB configuration different than the first SSB configuration;
re-determining, based on the updated SSB configuration, whether the ROs of the set of ROs are valid or invalid and whether the POs of the set of POs are valid or invalid; and
monitoring in the set of ROs and the set of POs based on the determination of the valid or invalid ROs and the valid or invalid POs.
